(19) United States
(12) Patent Application Publication
(10) Pub. No.: US 2005/0187975 A1
(43) Pub. Date: Aug. 25, 2005

(54) Similarity determination program, multimedia-data search program, similarity determination method, and similarity determination apparatus

(75) Inventor: Yasuo Yamane, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/915,518

(22) Filed: Aug. 9, 2004

(30) Foreign Application Priority Data
Feb. 20, 2004 (JP) 2004-045135

(51) Int. Cl. G06F 7/00

(52) U.S. Cl. 707/104.1

(57) ABSTRACT

A similarity determination program which improves discriminability in determination of similarity between multimedia-data items. An input unit inputs multimedia-data items to be compared, and a vector-set generation unit analyzes the multimedia-data items, and generates feature vectors, which constitute vector sets. Next, a vector-pair generation unit generates vector pairs, where each vector pair is formed of feature vectors, one of which is extracted from one of the vector sets and the other of which is extracted from another of the vector sets. Then, a vector-to-vector distance calculation unit calculates distances in the respective vector pairs, where each of the distances indicates a first degree of similarity between the feature vectors forming one of the vector pairs. Subsequently, a degree-of-similarity calculation unit calculates a second degree of similarity between the multimedia-data items by summing the distances calculated by the vector-to-vector distance calculation unit

### CROSS-REFERENCE TO RELATED APPLICATIONS

This application is based upon and claims priority of Japanese Patent Application No. 2004-045135, filed on Feb. 20, 2004, the contents being incorporated herein by reference.

### BACKGROUND OF THE INVENTION

1) Field of the Invention

The present invention relates to a similarity determination program, a multimedia-data search program, a similarity determination method, and a similarity determination apparatus. In particular, the present invention relates to a similarity determination program, a multimedia-data search program, a similarity determination method, and a similarity determination apparatus for determining a degree of similarity between multimedia-data items.

2) Description of the Related Art

In the field of computers, conventionally searches have been conducted based on character strings and numerical values which represent, for example, keywords. However, with the recent widespread use of the Internet, digital cameras, mobile telephones, and the like, interest in searches for multimedia data such as images, sounds, and documents is growing.

The search based on an annotation or a keyword is a method for searching for multimedia-data items. In this method, a group of keywords called an annotation is attached to each image for searching. For example, the keywords are a text phrase such as “deep blue sea shot in Okinawa,” or words such as “Okinawa” and “sea.” Conventionally, keyword searches for images have been conducted based on keywords attached to the images. However, the above method for searching based on annotations has two problems.

The first problem is that the human cost for attachment of annotations is great. Further, the attachment of annotations is becoming more difficult with the rapid increase in the numbers of images. The second problem is that the features of the images cannot be completely described by the annotations. Actually, the images have various features such as colors, shapes, and patterns, which cannot be completely characterized by characters.

Therefore, a method for searching for a multimedia-data item by automatically extracting a feature of the multimedia-data item, and using a feature space, a color histogram, and a feature quantity is known. The image data is multimedia data to which this method can be applied. In the similarity search of image data, features such as colors and shapes are automatically extracted as numerical values without human assistance. A typical method frequently used in the case of colors is a method called the color histogram, where the histogram means a bar graph.

In the color histogram, pixels are classified into n colors, and the number of pixels having each color is extracted, where n is a natural number. Then, the feature concerning each color is represented by the proportion of the number of pixels having the color to the total number of the pixels in the entire image. A quantity which represents a feature, as the above proportion, is called a feature quantity. The above number n of color classification should be a rather large number such as 64.

Consider a simple case where n=3, and the pixels are classified into the three primary colors, red, green, and blue. In this case, a feature quantity of an image can be represented by coordinates in a three-dimensional feature space.

FIG. 18 is a diagram illustrating feature quantities of an image based on a color histogram. In FIG. 18, the coordinate axes corresponding to the feature quantities for red, green, and blue are arranged to be orthogonal to each other. Assume that the proportion of the number of pixels having each color to the total number of the pixels in the entire image is the feature quantity concerning the color, and the feature quantities of the image concerning red, green, and blue are 0.2, 0.5, and 0.3, respectively. That is, the image is represented as a point A having the coordinates

$$( \begin{matrix}0.2 \\ 0.5 \\ 0.3\end{matrix} ) . \qquad ( 1 )$$

FIG. 19 is a diagram illustrating three points A, B, and C representing three images, where the three points A, B, and C have the following coordinates, respectively.

$$\begin{matrix}A = ( \begin{matrix}0.2 \\ 0.5 \\ 0.3\end{matrix} ) & ( 2 ) \\ B = ( \begin{matrix}0 \\ 0.5 \\ 0.5\end{matrix} ) & ( 3 ) \\ C = ( \begin{matrix}1.0 \\ 0 \\ 0\end{matrix} ) & ( 4 )\end{matrix}$$

In the above case, the point B represents an image which does not contain red, and the point C represents an image which does not contain green and blue. When attention is focused on the distances between three points, images are regarded to be similar when the distance between the points representing the images is small. As understood from FIG. 19, since the point A is nearer to the point B than to the point C, the image represented by the point A is regarded as being similar to the image represented by the point B. Therefore, when an image most similar to the image represented by the point A is searched for, the image represented by the point B is detected.

As described above, the basic concept of the similarity search is that one-to-one correspondences are set between images and points in a feature space, and images corresponding to points nearer to each other are regarded as more similar to each other.

The similarity search as above are used in various fields. For example, the similarity search using a feature space is widely used in the fields of sounds and documents as well as the fields of images including movies. For example, in the case of similarity search in the fields of sounds, when an introduction to a piece of music is inputted, the piece of music is searched for. In the case of similarity search in the fields of documents, a frequently used feature quantity of a document is a product of a frequency of occurrence of a word contained in the document and a logarithm of the total number of documents divided by the number of documents containing the word. In this case, the dimension of the feature space is the number of words considered as bases. Therefore, the dimension of the feature space is very great. Thus, the similarity search using a feature quantity are widely used for a variety of multimedia data.

As described above, in the similarity search, a feature of an object such as a document or an image as a multimedia data item is associated with a vector (point) in a multidimensional space called a feature space, where the coordinates of the point indicate the feature quantities of the object. In most cases, the feature quantities are represented in floating-point format. That is, in most cases, the feature space is an n-dimensional space with coordinates represented by real numbers.

Hereinbelow, the meanings of the terms “base” and “feature vector,” which will be frequently used in this specification, are explained.

[Base and Normalized Orthogonal Bases]

As is well known, an arbitrary vector in a so-called vector space such as a Euclidean space can be represented by using n vectors called base vectors when the dimension of the vector space is n. In the case of a three-dimensional Euclidean space, the following three vectors e₁, e₂, and e₃ are base vectors.

$$\begin{matrix}{e}_{1} = ( \begin{matrix}1 \\ 0 \\ 0\end{matrix} ) & ( 5 ) \\ {e}_{2} = ( \begin{matrix}0 \\ 1 \\ 0\end{matrix} ) & ( 6 ) \\ {e}_{3} = ( \begin{matrix}0 \\ 0 \\ 1\end{matrix} ) & ( 7 )\end{matrix}$$

An arbitrary vector v can be expressed as a so-called linear combination of the above base vectors as follows.

$$v = ( \begin{matrix}{x}_{1} \\ {x}_{2} \\ {x}_{3}\end{matrix} ) = {x}_{1} {e}_{1} + {x}_{2} {e}_{2} + {x}_{3} {e}_{3} \qquad ( 8 )$$

The set of the above n base vectors is called a basis. That is, the basis corresponds to the coordinate system, and conversely the coordinate system can be conceived based on the basis.

The set of the base vectors e₁, e₂, and e₃ in the above example are called a (normalized) orthogonal basis. The expression “orthogonal” means that the base vectors eᵢ and eⱼ are perpendicular to each other, where i and j are natural numbers, and i≠j. In addition, the expression “normalized” means that the length of each of the base vectors is “1.”

[Feature Vector]

Hereinafter, the vector expressed by the following linear combination (9) is called an entire-feature vector corresponding to an object,
f=c₁e₁+c₂e₂+ . . . +cₙeₙ (9)
where the dimension of the feature space is n, the vectors e₁, e₂, e₃, . . . , eₙ are the base vectors of the feature space, and the feature quantities of the object are c₁, c₂, C₃, . . . Cₙ. The entire-feature vector represents an overall feature of the object. The distance between objects is measured as the distance between the entire-feature vectors corresponding to the objects, whereas the feature quantities are quantities indicating respective features of the object.

[Orthogonal Basis+Euclidean Distance]

In the most basic method, n feature quantities are represented as a point x in an n-dimensional Euclidean space as expressed below.

$$x = ( \begin{matrix}{x}_{1} \\ {x}_{2} \\ ⋮ \\ {x}_{n}\end{matrix} ) \qquad ( 10 )$$

The distance between two points is represented as an Euclidean distance. That is, when another point is expressed as

$$y = ( \begin{matrix}{y}_{1} \\ {y}_{2} \\ ⋮ \\ {y}_{n}\end{matrix} ) , \qquad ( 11 )$$

the distance d between the above points is expressed as follows.
d=\sqrt{(x₁−y₁)²+(x₂−y₂)²+ . . . +(xₙ−yₙ)²}. (12)

However, the above method has the problems explained below.

For example, consider a case where the number of colors is twelve. At this time, the twelve colors can be expressed by a hue circle. FIG. 20 is a diagram illustrating a hue circle. In the hue circle, a plurality of colors are arranged in such a manner that similar colors are located adjacent to each other. The color most dissimilar to each color is located diametrically opposite to each color, and called a complementary color. Note that the hue circle illustrated in FIG. 20 is simplified from the actual hue circle for clarifying illustrations, and the names of the colors in FIG. 20 are different from the normally used names. For example, “green-blue” in FIG. 20 means “greenish blue,” “yellow-green” in FIG. 20 means “yellowish green,” “green-yellow” in FIG. 20 means “greenish yellow,” “yellow-orange” in FIG. 20 means “yellowish orange,” and “red-orange” in FIG. 20 means “reddish orange.” In the case based on the hue circle of FIG. 20, each image can be represented in a twelve-dimensional feature space by the color-histogram method. Hereinbelow, in order to clarify the explanations, three monochromatic images respectively colored red, red-orange, and green are considered. These images can be respectively represented as follows.

$$\begin{matrix}Red = ( \begin{matrix}1.0 \\ 0 \\ 0 \\ 0 \\ 0 \\ 0 \\ 0 \\ 0 \\ 0 \\ 0 \\ 0 \\ 0\end{matrix} ) & ( 13 ) \\ ( Red \text{-} Orange ) = ( \begin{matrix}0 \\ 1.0 \\ 0 \\ 0 \\ 0 \\ 0 \\ 0 \\ 0 \\ 0 \\ 0 \\ 0 \\ 0\end{matrix} ) & ( 14 ) \\ Green = ( \begin{matrix}0 \\ 0 \\ 0 \\ 0 \\ 0 \\ 0 \\ 1.0 \\ 0 \\ 0 \\ 0 \\ 0 \\ 0\end{matrix} ) & ( 15 )\end{matrix}$$

FIG. 21 is a diagram illustrating feature quantities of each of the monochromatic red, red-orange, and green images. In FIG. 21, coordinate axes corresponding to the other colors are not shown. As understood from FIG. 20, the distances between the images are calculated by using the formula (12) for calculating the distances, as follows.
Distance between Red and Green=2^{1/2}
Distance between Red and Red-orange=2^{1/2}
Distance between Red-orange and Green=2^{1/2}

Since the distance between any two of the images is identical, numerically the degree of similarity between each pair of the images is regarded as identical. However, when human beings see the above three colors, blue-green and red do not look similar, whereas red and red-orange look similar. That is, the similarity perceived by human beings is not reflected in the manner in which the points are arranged in the feature space. This problem occurs not only in the cases of images, and can generally occur in every type of multimedia data. An example of text data is indicated below.

[Example of Document]

Although normally each document contains a number of words, three simple documents each of which is composed of only one word are considered below for simple explanation of representation of documents in a feature space.
Document 1={premier}
Document 2={chancellor}
Document 3={tennis}

Assume that the set of the words {premier, chancellor, tennis} are considered as bases, and the feature quantity corresponding to the ith dimension is the number of occurrences of the ith word in the bases. In this case, the above documents can be represented by the following vectors, respectively.

$$\begin{matrix}Document 1 = ( \begin{matrix}1 \\ 0 \\ 0\end{matrix} ) & ( 16 ) \\ Document 2 = ( \begin{matrix}0 \\ 1 \\ 0\end{matrix} ) & ( 17 ) \\ Document 3 = ( \begin{matrix}0 \\ 0 \\ 1\end{matrix} ) & ( 18 )\end{matrix}$$

As in the case of the images, the distance between each pair of the documents is calculated as follows.
Distance between the documents 1 and 2=2^{1/2}
Distance between the documents 2 and 3=2^{1/2}
Distance between the documents 3 and 1=2^{1/2}
   The degree of similarity between each pair of the documents is identical. However, actually the words “premier” and “chancellor” have substantially identical meanings. That is, the similarity perceived by human beings is not reflected in the manner in which the points are arranged in the feature space, as in the case of the images.

[Orthogonal Basis+Quadratic-form Distance]

Various methods have been proposed for solving the aforementioned problem in the use of the orthogonal basis and the Euclidean distance. Basically, the orthogonal basis is also used in the proposed methods. However, in the proposed methods, distance functions d(x, y) in which similarity between features is reflected are used instead of the aforementioned Euclidean distance, where d(x, y) indicates a distance between two points x and y.

Although it is easy to calculate the Euclidean distance, which is used in the aforementioned method based on the orthogonal basis and the Euclidean distance, the distance functions used in the proposed methods are generally complex, and in most cases it takes much time to perform calculation based on the distance functions. Therefore, it is necessary to solve this problem.

Hereinbelow, the quadratic-form distance, which is obtained by the most typical one of the above distance functions, is explained.

When a vector x is expressed as

$$x = ( \begin{matrix}{x}_{1} \\ {x}_{2} \\ {x}_{3} \\ ⋮ \\ {x}_{n}\end{matrix} ) , \qquad ( 19 )$$

the length ∥x∥ of the vector x is defined by using a matrix S as

$${‖ x ‖}^{2} {=}^{t} xSx = \\ ( {x}_{1} , {x}_{2} , ⋯ , {x}_{n} ) ( \begin{matrix}{S}_{11} & {S}_{12} & {S}_{13} & ⋯ & {S}_{1 n} \\ {S}_{21} & {S}_{22} & {S}_{23} & ⋯ & {S}_{2 n} \\ {S}_{31} & {S}_{32} & {S}_{33} & ⋯ & {S}_{3 n} \\ ⋯ & ⋯ & ⋯ & ⋯ & ⋯ \\ {S}_{n1} & {S}_{n2} & {S}_{n3} & ⋯ & {S}_{nn}\end{matrix} ) ( \begin{matrix}{x}_{1} \\ {x}_{2} \\ {x}_{3} \\ ⋯ \\ {x}_{n}\end{matrix} ) , \\ \qquad ( 20 )$$

where ^{t}x is a transposed vector of the vector x. For example, when x is a column vector, the transposed vector ^{t}x is a row vector. Therefore, the distance d (x, y) between the vectors x and y is obtained as the length of a difference vector between the vectors x and y,
d(x, y)²=^{t}(x−y)S(x−y). (21)
The matrix S is a matrix indicating similarity between features, and is hereinafter referred to as a similarity matrix. Each element Sᵢⱼ of the matrix is called a degree of similarity, and indicates a degree of similarity between the ith and jth features. When the matrix is a unit matrix, the quadratic-form distance is the normal Euclidean distance. In this sense, the quadratic-form distance is a generalization of the Euclidean distance. The method based on the quadratic-form distance is used in the QBIC (Query By Image Contact) system of IBM Corporation, where QBIC is a trademark of IBM Corporation. For example, see James Hafner et al., “Efficient Color Histogram Indexing for Quadratic Form Distance Functions,” IEEE Trans. Pattern Anl. Machine Intell. 17(7), pp. 729-736 (1995).

[Oblique Basis+Euclidean Distance]

A similarity search method using an oblique basis corresponding to an oblique coordinate system has also been proposed. As well known in mathematics, the angles between oblique base vectors are not required to be 90 degrees. Coordinates based on oblique base vectors, which are not necessarily perpendicular to each other, are called oblique coordinates, and are widely used in a number of technical fields as well as in mathematics and physics. In this specification, a basis constituted by oblique base vectors is referred to as an oblique basis.

FIG. 22 is a diagram illustrating an example of an oblique basis. In the oblique basis illustrated in FIG. 22, an oblique base vector corresponding to red-orange is arranged near to an oblique base vector corresponding to red in consideration of similarity between red and red-orange.

FIG. 23 is a diagram provided for explaining a relationship between orthogonal coordinates and oblique coordinates. In FIG. 23, the orthogonal coordinates of the point P are [8, 7]. Consider a basis comprised of oblique base vectors e₁ and e₂, each of which is represented by orthogonal coordinates as

$$\begin{matrix}{e}_{1} = ( \begin{matrix}2 \\ 1\end{matrix} ) , and & ( 22 ) \\ {e}_{2} = ( \begin{matrix}1 \\ 2\end{matrix} ) . & ( 23 )\end{matrix}$$

In order to represent the point P by oblique coordinates, points A and B are obtained, where the point A is an intersection of a line passing through the point P and being parallel to the oblique base vector e₂ and a line containing the oblique base vector e₁, and the point B is an intersection of a line passing through the point P and being parallel to the oblique base vector e₁ and a line containing the oblique base vector e₂. Hereinafter, generally a vector from a point X to a point Y is referred to as a vector XY. In the example of FIG. 23, the vector OP is defined as a vector sum of the vector OA and the vector OB, i.e., vector OP=vector OA+vector OB. Since vector OA=3e₁ and vector OB=2e₂, it is possible to express as vector OP=3e₁+2e₂. At this time, the coefficients “3” and “2” of e₁ and e₂ become the oblique coordinates of the point P, i.e., the oblique coordinates of the point P are expressed as

$$( \begin{matrix}3 \\ 2\end{matrix} ) . \qquad ( 24 )$$

The oblique coordinates and the orthogonal coordinates of the point P have the following relationship.

$$( \begin{matrix}8 \\ 7\end{matrix} ) = 3 {e}_{1} + 2 {e}_{2} = 3 ( \begin{matrix}2 \\ 1\end{matrix} ) + 2 ( \begin{matrix}1 \\ 2\end{matrix} ) = ( \begin{matrix}2 & 1 \\ 1 & 2\end{matrix} ) ( \begin{matrix}3 \\ 2\end{matrix} ) \qquad ( 25 )$$

The rightmost side of the above equations expresses a product of a matrix and a vector. In this specification, the above matrix is referred to as a feature-vector conversion matrix (from oblique coordinates to orthogonal coordinates). The above matrix, which is denoted T, can be produced by arranging the elements of the oblique base vectors e₁ and e₂ in order, i.e., T=(e₁ e₂).

The basic concept of the method using the oblique basis is to reflect similarity in the distances between oblique base vectors. In this method, the distance function of the Euclidean distance is uses as it is. In this case, calculation of the distance is easy. In addition, the distance between two objects obtained by this method is basically identical to the quadratic-form distance. That is, from the viewpoint of precision, the distance between two objects according to the method using the oblique basis is basically equivalent to the quadratic-form distance. However, the amount of data required to be stored in the method using the oblique basis is almost half of the amount of data required to be stored in the method using the quadratic-form distance. Further, the amount of data required to be stored affects the processing speed. Therefore, the small amount of data required to be stored is an advantage of the method using the oblique basis.

In a method used in an idea of a prototype of the oblique basis, a new feature vector is produced by converting a feature vector represented by orthogonal coordinates by use of the aforementioned matrix T, instead of a linear combination based on the oblique basis. For example, see Jack. S. N. Jean, “A New Distance Measure for Binary Images,” Proceedings of the 1990 IEEE International Conference on Acoustics, Speech and Signal Processing (ICASSP '90), Apr. 3-6, 1990, Vol. 4, pp. 2061-2064 (paper#: 2061).

Concerning the method using the oblique basis, the present assignee has filed a Japanese patent application No. 2003-172217, “Apparatus for Similarity Search of Image Data and Method for Determining Similarity in the Apparatus,” on Jun. 17, 2003.

Further, a technique for searching for a similar image, which is called the Earth Mover's Distance (EMD) technique, is known. Hereinbelow, this technique is briefly explained.

According to the EMD technique, similarity between images is determined based on distances between a plurality of points. The definition of this distance is briefly explained below by comparison to a transportation problem between holes and masses of earth. This distance is based on a solution of the transportation problem.

First, sets x and y each called a signature are defined in correspondence with respective images, as follows.
x={(p₁, x₁), (p₂, x₂), . . . (pₘ, xₘ)}
y={(q₁, y₁), (q₂, y₂) , (qₙ, yₙ)} (26)
In the above definitions, the set x corresponds to a set of masses of earth, the set y corresponds to a set of holes, and m and n are natural numbers. Generally, it is unnecessary that m and n are identical. This flexibility is one of the features of EMD. In addition, pᵢ and qⱼ each indicate a point in a space in which an arbitrary distance is defined. It is assumed that xᵢ indicates an amount of earth placed at the point pᵢ, yⱼ indicates the capacity of a hole excavated at the point qⱼ, and the total amount of the earth is sufficient to fill all of the holes. When the distance between the points pᵢ and qⱼ is denoted dᵢⱼ, and the amount of earth transported from the point pi to the point qⱼ, is denoted fᵢⱼ, the cost for filling all of the holes is expressed as

$${\sum }_{i = 1}^{m} {\sum }_{j = 1}^{n} {d}_{ij} {f}_{ij} . \qquad ( 27 )$$

Then, the amounts fᵢⱼ which minimize the above cost are obtained, and the EMD between the sets x and y is defined as

$$EMD ( x , y ) = \frac{{\sum }_{i = 1}^{m} {\sum }_{j = 1}^{n} {d}_{ij} {f}_{ij}}{{\sum }_{i = 1}^{m} {\sum }_{j = 1}^{n} {f}_{ij}} . \qquad ( 28 )$$

In the formula (28), the denominator is provided for normalization, which prevents the tendency toward selection of a signature corresponding to a small total amount. In the technique disclosed by Yosshi Rubner et al. (“A Metric for Distribution with Applications to Image Databases,” Proceedings of the 1998 IEEE International Conference on Computer Vision, January 1998, pp. 59-66), the EMD is applied to the colors and textures (patterns) of images. In addition, the above definition of the EMD can cope with partial matching in the case where the total numbers of feature quantities in the two signatures are different. Unlike the aforementioned methods using the color histogram, the EMD technique is so flexible that the numbers m and n of elements can be arbitrarily designated. In addition, according to the EMD technique, it is easy to calculate the lower limit of the distance.

However, the conventional techniques lack discriminability.

FIG. 24 is a diagram in which the problems of the conventional techniques except for the EMD technique are tabulated. In FIG. 24, the subheading “REJECT SIMILAR OBJECT” under the column heading “TENDENCY TO . . . ” means a tendency to determine a similar object to be dissimilar. When one of the methods has this tendency, a blank circle (O) is indicated in the row corresponding to the method under the subheading “REJECT SIMILAR OBJECT”. As explained before, the method using the orthogonal basis and the Euclidean distance has this tendency.

On the other hand, the subheading “SELECT DISSIMILAR OBJECT” under the column heading “TENDENCY TO . . . ” means a tendency to determine a dissimilar object to be similar. When one of the methods has this tendency, a blank circle (O) is indicated in the row corresponding to the method under the subheading “SELECT DISSIMILAR OBJECT”. The method using the orthogonal basis and the quadratic-form distance and the method using the oblique basis and the Euclidean distance, in both of which similarity between features is taken into consideration, have the tendency to determine a dissimilar object to be similar. According to these methods, in extreme cases, completely different objects are determined to be similar. In this specification, this drawback is called “lack of discriminability,” and the object of the present invention is to overcome the lack of discriminability as indicated later.

FIG. 25 is a diagram illustrating an oblique basis in which the similarity between features in a hue circle is directly reflected. In the case of FIG. 25, the entire-feature vector of an image composed of 50% of red pixels and 50% of green pixels and the entire-feature vector of an image composed of 50% of yellow pixels and 50% of blue pixels each become a zero vector. That is, the similarity search based on the oblique basis of FIG. 25 determines images having completely different colors to be identical. This is because the twelve vectors e₁, e₂, e₃, . . . , e₁₂ illustrated in FIG. 25 are not linearly independent. Therefore, although the twelve vectors e₁, e₂, e₃, . . . e₁₂ are assumed to be base vectors in FIG. 25, mathematically the twelve vectors e₁, e₂, e₃, . . . , e₁₂ are not base vectors. In this specification, on some occasions, vectors such as the above twelve vectors e₁, e₂, e₃, . . . , e₁₂ are also referred to as base vectors.

Referring back to FIG. 24, advantages and disadvantages of the respective methods are summarized below from the viewpoints of the lack of discriminability and performance maintenance. In FIG. 24, information on the similarity between features, discriminability, the amount of calculation, and the amount of stored data are indicated for each method. The information on the similarity between features indicates whether or not the similarity between features is reflected in results of each method. The information on the discriminability indicates whether or not dissimilar objects are correctly discriminated from each other. The information on the amount of calculation indicates whether or not the number of calculation steps is small. The information on the amount of stored data indicates whether or not the necessary memory capacity is small. In each field in FIG. 24 corresponding to one of the methods, yes is indicated by a blank circle (O), and no is indicated by a cross (X). When it is impossible to determine yes or no, a triangle (Δ) is indicated in the corresponding field in FIG. 24.

As illustrated in FIG. 24, the similarity between features is not reflected in results of any of the above methods having satisfactory discriminability. However, the method using the oblique basis and the Euclidean distance exhibits satisfactory characteristics except for the discriminability. Therefore, it is desirable to improve the discriminability of the method using the oblique basis and the Euclidean distance without impairing the current performance.

In the case of the EMD technique, partial matching is performed when the total numbers of feature quantities in the two signatures are different. When comparison to the transportation problem between a set of masses of earth and a set of holes is used again for explanation, comparison processing for similarity search is completed at the time all of the masses of earth are exhausted for filling the holes, even if a portion of the holes is left unfilled. Therefore, when all of features of a first object are similar to a portion of features of a second object, the first and second objects are determined to be similar, even if the first object is dissimilar to the second object as a whole. That is, in the case where the total numbers of feature quantities of two objects are different, it is advantageous that partial matching is possible. However, when similarity between entire objects is considered, an object which is dissimilar as a whole can be selected, i.e., discriminability is impaired.

### SUMMARY OF THE INVENTION

The present invention is made in view of the above problems, and the object of the present invention is to provide a similarity determination program, a multimedia-data search program, a similarity determination method, and a similarity determination apparatus, in which discriminability in determination of similarity by comparison of entire multimedia-data items is improved.

In order to accomplish the above object, a similarity determination program is provided for determining similarity between multimedia-data items by using a computer. The similarity determination program makes the computer comprise the functions of: an oblique-base-vector storage unit which stores oblique base vectors being respectively provided in correspondence with representative features of the multimedia-data items, and respectively indicating the representative features by directions of the oblique base vectors; an input unit which inputs first and second multimedia-data items to be compared; a vector-set generation unit which analyzes the first and second multimedia-data items inputted by the input unit, determines feature quantities, respectively corresponding to the representative features, of each of the first and second multimedia-data items so that each of the feature quantities indicates a degree of inclusion of information corresponding to one of the representative features in each of the first and second multimedia-data items, generates first and second feature vectors for the first and second multimedia-data items, respectively, by multiplying each of the oblique base vectors by one of the feature quantities corresponding to the oblique base vector for each of the first and second multimedia-data items, and forms first and second vector sets respectively corresponding to the first and second multimedia-data items so that the first feature vectors constitute the first vector set, and the second feature vectors constitute the second vector set; a vector-pair generation unit which makes the first and second vector sets have an identical number of feature vectors, and generates a plurality of vector pairs by establishing one-to-one correspondences between the feature vectors in the first vector set and the feature vectors in the second vector set; a vector-to-vector distance calculation unit which calculates distances in the plurality of vector pairs, respectively, where each of the distances indicates a first degree of similarity between two feature vectors forming one of the plurality of vector pairs; a degree-of-similarity calculation unit which calculates a second degree of similarity between the first and second multimedia-data items by summing the distances calculated by the vector-to-vector distance calculation unit; and an output unit which outputs the second degree of similarity calculated by the degree-of-similarity calculation unit.

Further, in order to accomplish the aforementioned object, a multimedia-data search program for searching multimedia-data items by using a computer is provided. The multimedia-data search program makes the computer comprise the functions of: an oblique-base-vector storage unit which stores oblique base vectors being respectively provided in correspondence with representative features of multimedia-data items, and respectively indicating the representative features by directions of the oblique base vectors; a vector-set storage unit which stores first vector sets each including first feature vectors representing features of each of first multimedia-data items which are to be searched; an input unit which inputs a second multimedia-data item as a search condition; a vector-set generation unit which analyzes the second multimedia-data item inputted by the input unit, determines feature quantities, respectively corresponding to the representative features, of the second multimedia-data items so that each of the feature quantities indicates a degree of inclusion of information corresponding to one of the representative features in the second multimedia-data item, generates second feature vectors for the second multimedia-data item by multiplying each of the oblique base vectors by one of the feature quantities corresponding to the oblique base vector, and forms a second vector sets constituted by the second feature vectors; a vector-pair generation unit which makes the first vector sets and the second vector sets have an identical number of feature vectors, and generates a plurality of vector pairs by establishing one-to-one correspondences between the feature vectors in each of the first vector sets and the feature vectors in the second vector set; a vector-to-vector distance calculation unit which calculates distances in the plurality of vector pairs, respectively, where each of the distances indicates a first degree of similarity between two feature vectors forming one of the plurality of vector pairs; a degree-of-similarity calculation unit which calculates a second degree of similarity between the second multimedia-data item and each of the first multimedia-data items by summing the distances calculated by the vector-to-vector distance calculation unit; and an output unit which outputs information identifying one of the first multimedia-data items corresponding to a highest value of the second degree of similarity calculated by the degree-of-similarity calculation unit.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a conceptual diagram illustrating the present invention which is realized in an embodiment;

FIG. 2 is a schematic diagram illustrating an example of determination of a degree of similarity of image data;

FIG. 3 is a diagram illustrating an example of a hardware construction of a multimedia-data search apparatus;

FIG. 4 is a diagram illustrating a function block diagram of the multimedia-data search apparatus;

FIG. 5 is a diagram illustrating the Munsell color solid;

FIG. 6 is a diagram illustrating a relationship among the hue, the brightness (lightness), and the saturation (chroma) as the three properties of the color;

FIG. 7 is a diagram briefly illustrating an arrangement of colors on the Munsell color solid;

FIG. 8 is a diagram illustrating an oblique basis in the case where a=1;

FIG. 9 is a diagram illustrating two vector sets to be compared;

FIG. 10 is a diagram illustrating examples of vector sets in a multivector feature space;

FIG. 11 is a diagram illustrating examples of multivector distances between images;

FIG. 12 is a diagram illustrating δ-distances between images by using multivector distances;

FIG. 13 is a diagram illustrating examples of multiple vectors which are not linearly independent;

FIG. 14 is a diagram illustrating divided vectors;

FIG. 15 is a diagram illustrating an example of two vectors produced by equally dividing a single vector;

FIG. 16 is a diagram illustrating an example of unequal division of a single vector;

FIG. 17 is a flowchart indicating a sequence of processing for approximate calculation of a D-distance;

FIG. 18 is a diagram illustrating feature quantities of an image based on a color histogram;

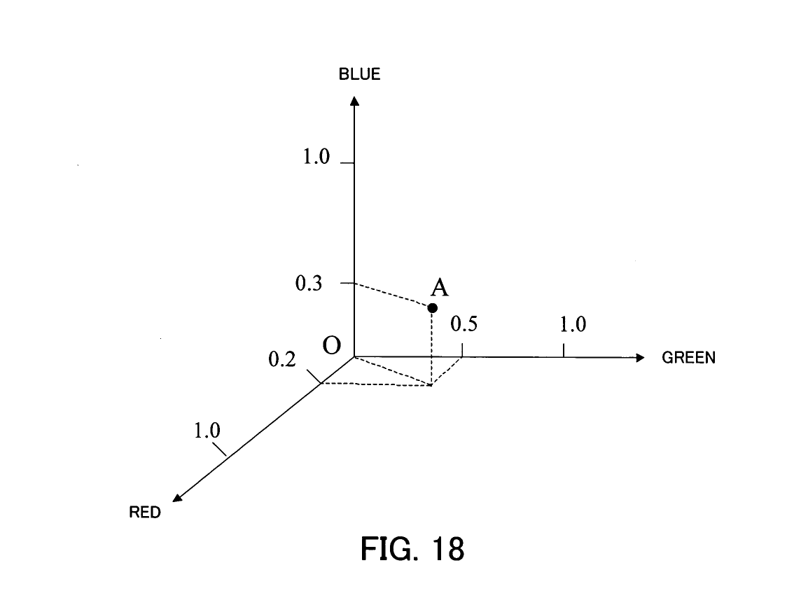

FIG. 19 is a diagram illustrating three points corresponding to three images;

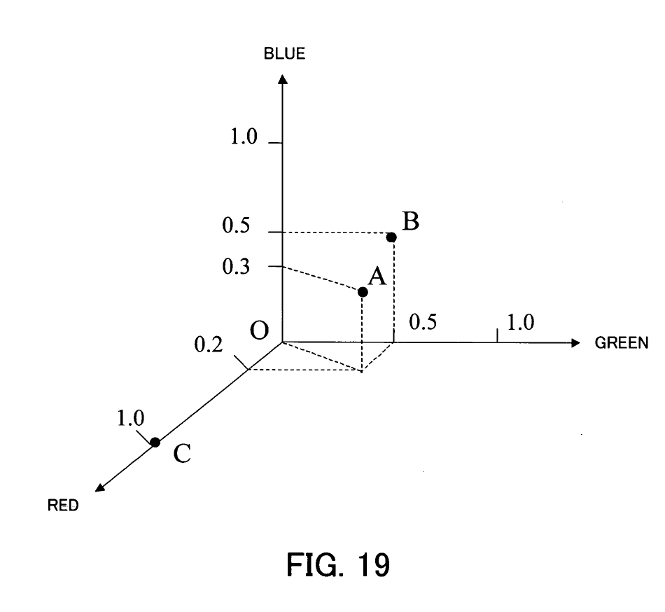

FIG. 20 is a diagram illustrating a hue circle;

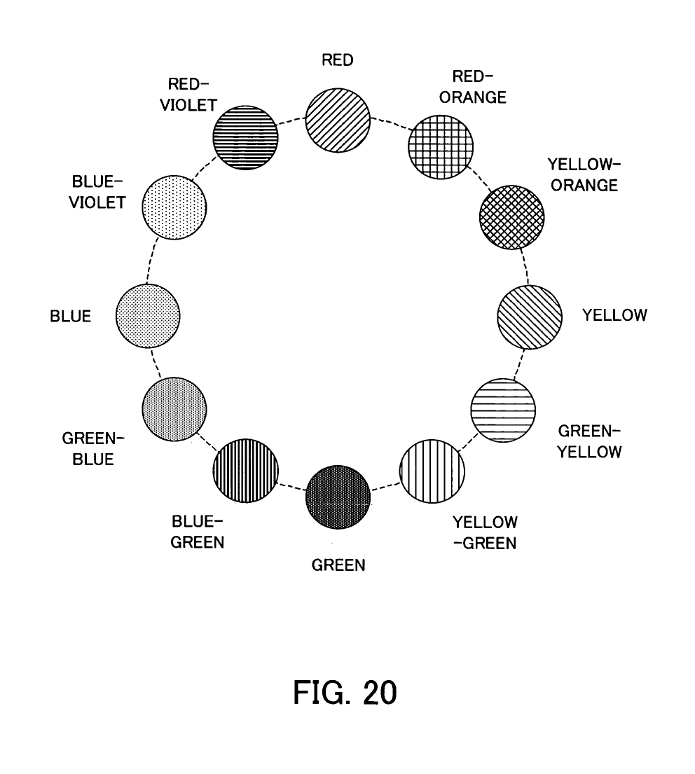

FIG. 21 is a diagram illustrating feature quantities of each of monochromatic red, red-orange, and green images;

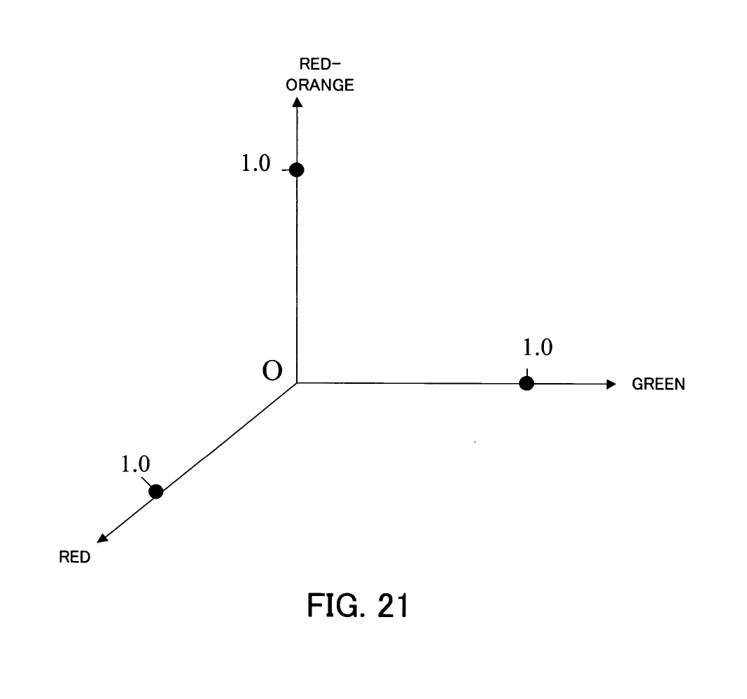

FIG. 22 is a diagram illustrating an example of an oblique basis;

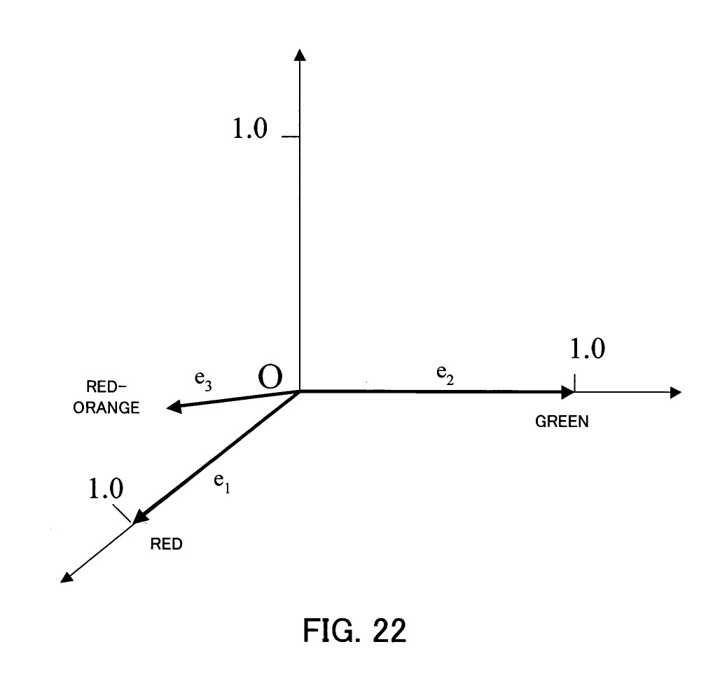

FIG. 23 is a diagram provided for explaining a relationship between orthogonal coordinates and oblique coordinates;

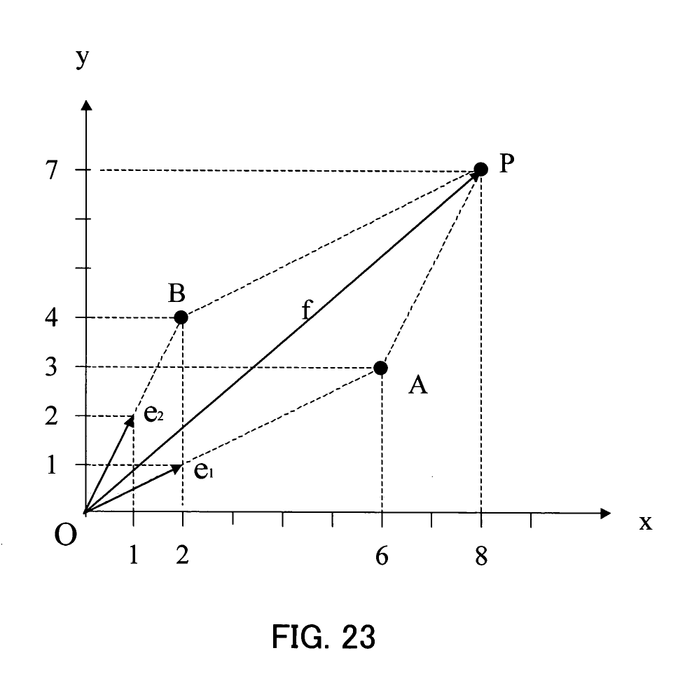

FIG. 24 is a diagram in which the problems of the conventional techniques are tabulated; and

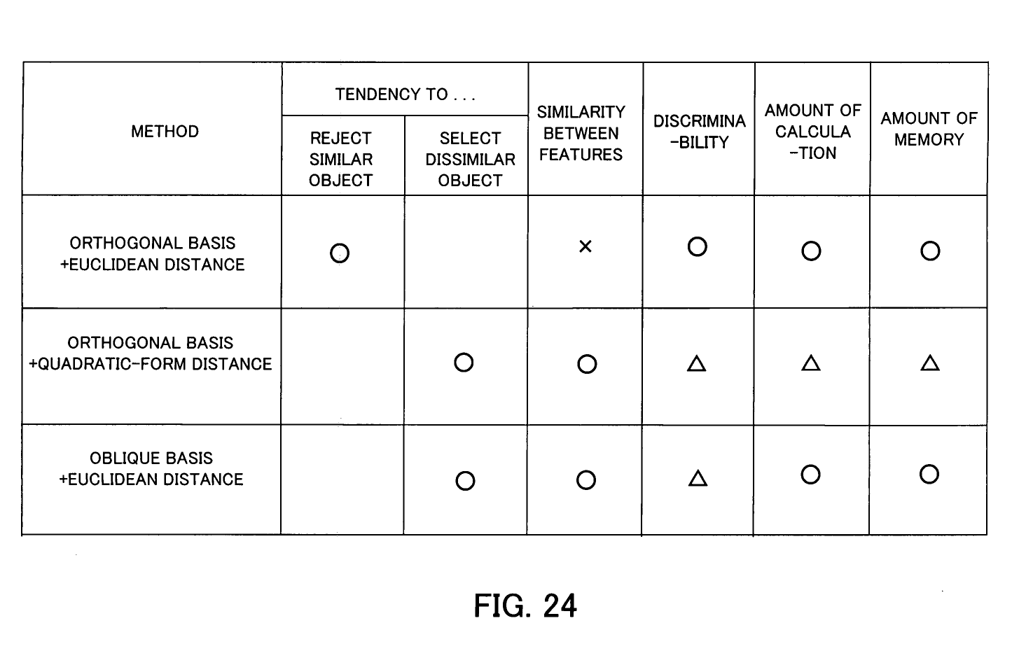

FIG. 25 is a diagram illustrating an oblique basis in which similarity between features in a hue circle is directly reflected.

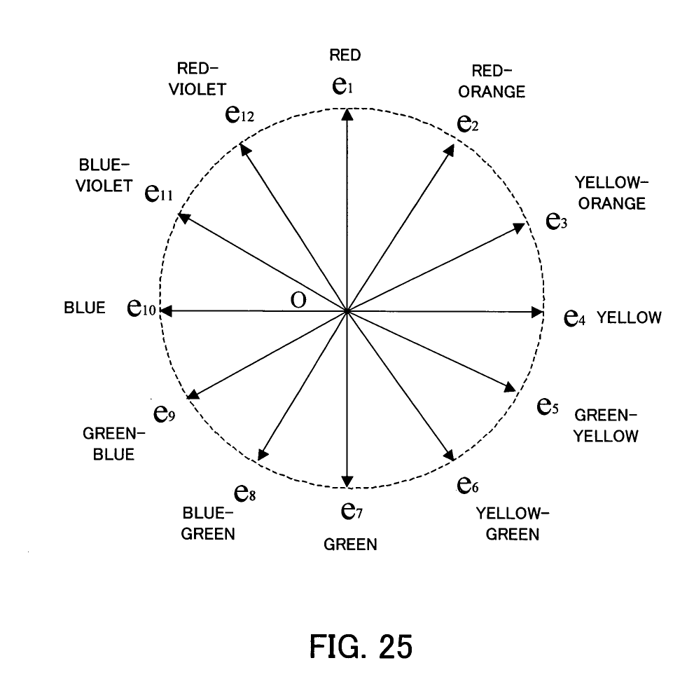

### DESCRIPTION OF THE PREFERRED EMBODIMENTS

An embodiment of the present invention is explained below with reference to drawings.

First, an outline of the present invention which is realized in the embodiment is explained, and thereafter details of the embodiment are explained.

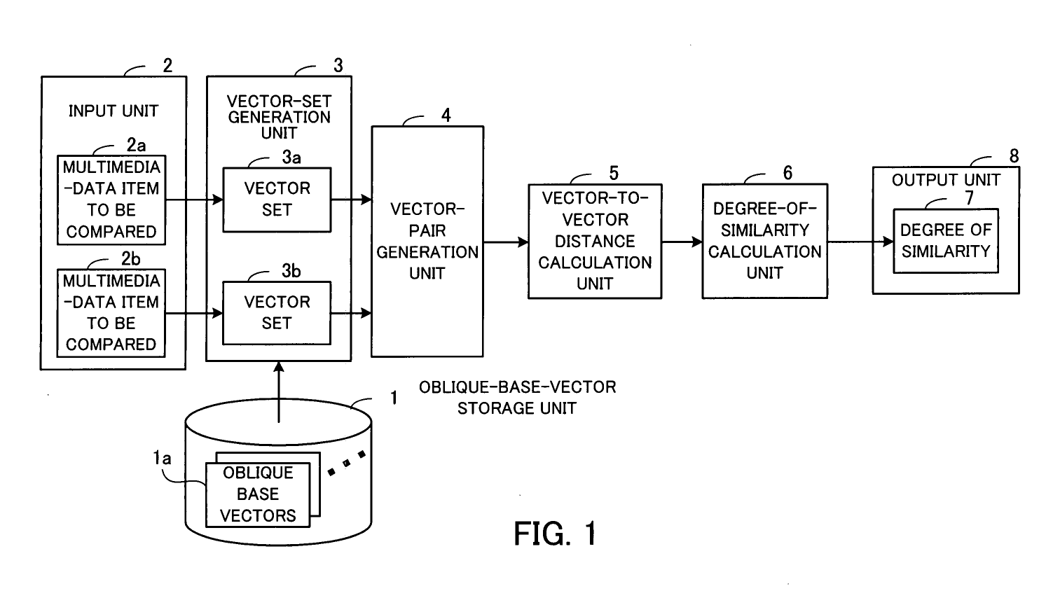

FIG. 1 is a conceptual diagram illustrating the present invention which is realized in the embodiment. The present embodiment comprises an oblique-base-vector storage unit 1, an input unit 2, a vector-set generation unit 3, a vector-pair generation unit 4, a vector-to-vector distance calculation unit 5, a degree-of-similarity calculation unit 6, and an output unit 8.

The oblique-base-vector storage unit 1 stores oblique base vectors 1a, each of which is arranged in correspondence with one of a plurality of representative features of multimedia-data items, and represents the representative feature by the direction of the oblique base vector. For example, when the multimedia-data items are image data items, a plurality of representative colors are defined as the representative features. The colors constituting a hue circle can be used as the representative colors. In this case, for example, each vector having a unit length and pointing to the position of one of the representative colors can be defined as one of the oblique base vectors 1a.

The input unit 2 inputs two multimedia-data items 2a and 2b which are to be compared. For example, the multimedia-data items 2a and 2b are designated by a user through an input device such as a keyboard, and the input unit 2 inputs the multimedia-data items 2a and 2b into the vector-set generation unit 3.

The vector-set generation unit 3 analyzes each of the multimedia-data items 2a and 2b, and determines a feature quantity indicating a degree of inclusion of information corresponding to each representative feature. Then, the vector-set generation unit 3 generates a feature vector by multiplying one of the oblique base vectors corresponding to each representative feature by the feature quantity corresponding to the representative feature, and sorts the generated feature vectors into groups corresponding to the multimedia-data items 2a and 2b, which are denoted vector sets 3a and 3b.

For example, in the case where the multimedia-data items are image data items, correspondences between the representative colors and colors which the image data items represent are predefined by the vector-set generation unit 3. The vector-set generation unit 3 determines the proportion of pixels corresponding to each of the representative colors in each image as the feature quantity corresponding to the representative feature (representative color).

The vector-pair generation unit 4 generates vector pairs each of which is formed of a first feature vector extracted from one of the vector sets 3a and 3b and a second feature vector extracted from the other of the vector sets 3a and 3b. For example, in order to generate the vector pairs, the vector-pair generation unit 4 extracts the first feature vector from the one of the vector sets 3a and 3b, and then extracts the second feature vector from the other of the vector sets 3a and 3b so that the second feature vector is directed in a direction nearest to the direction of the first feature vector among the feature vectors in the vector set 3b. It is possible to estimate the proximity of the directions of the feature vectors (being respectively extracted from the vector sets 3a and 3b and forming a vector pair) to each other by normalizing each of the feature vectors and calculating an inner product of the normalized feature vectors.

In addition, when the number of feature vectors included in the vector set 3a and the number of feature vectors included in the vector set 3b are not identical, the vector-pair generation unit 4 equalizes the numbers of the feature vectors included in the vector sets 3a and 3b. For example, the numbers can be equalized by dividing a portion of the feature vectors included in one of the vector sets 3a and 3b which includes a smaller number of feature vectors. When the numbers of feature vectors included in the vector sets 3a and 3b are identical, it is possible to calculate the degree of similarity 7 by using all of the feature vectors. That is, comparison can be performed on all of the feature vectors instead of the comparison performed in only a portion of the feature vectors. Further, when a feature vector is divided, for example, the division is performed so that the length of each of feature vectors produced by the division becomes equal to the length of a feature vector which is to be paired with the feature vector produced by the division.

The vector-to-vector distance calculation unit 5 calculates a distance indicating a degree of similarity between the feature vectors forming each vector pair generated by the vector-pair generation unit 4.

The degree-of-similarity calculation unit 6 calculates a sum of the distances calculated by the vector-to-vector distance calculation unit 5 so as to obtain the degree of similarity 7 between the multimedia-data items to be compared.

The output unit 8 outputs the degree of similarity 7 obtained by the degree-of-similarity calculation unit 6. For example, the output unit 8 causes display of the degree of similarity 7 on a screen, and stores the degree of similarity 7 in a hard disk device or the like.

In the above construction, the following processing is performed.

First, two multimedia-data items 2a and 2b are inputted by the input unit 2. Then, the vector-set generation unit 3 analyzes each of the multimedia-data items 2a and 2b inputted by the input unit 2, determines a feature quantity indicating a degree of inclusion of information corresponding to each representative feature, generates a feature vector by multiplying one of the oblique base vectors corresponding to each representative feature by the feature quantity corresponding to the representative feature, and generates vector sets 3a and 3b. Next, the vector-pair generation unit 4 generates vector pairs each of which is formed of a first feature vector extracted from one of the vector sets 3a and 3b and a second feature vector extracted from the other of the vector sets 3a and 3b. Subsequently, the vector-to-vector distance calculation unit 5 calculates a distance indicating a degree of similarity between feature vectors included in each vector pair generated by the vector-pair generation unit 4. Thereafter, the degree-of-similarity calculation unit 6 calculates a sum of the distances calculated by the vector-to-vector distance calculation unit 5 so as to obtain the degree of similarity 7 between the multimedia-data items to be compared, and then the output unit 8 outputs the degree of similarity 7 obtained by the degree-of-similarity calculation unit 6.

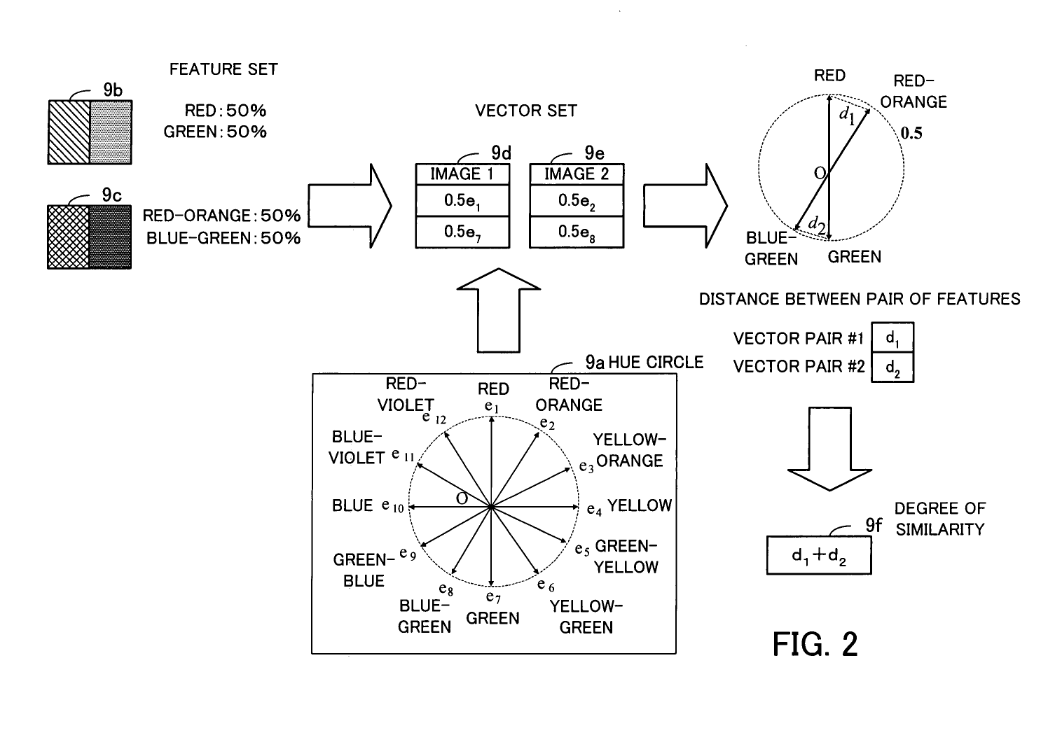

FIG. 2 is a schematic diagram illustrating an example of determination of a degree of similarity of image data. For example, a vector e₁ corresponding to “red” in the hue circle 9a, a vector e₂ corresponding to “red-orange” in the hue circle 9a, a vector e₃ corresponding to “yellow-orange” in the hue circle 9a, a vector e₄ corresponding to “yellow” in the hue circle 9a, a vector e₅ corresponding to “green-yellow” in the hue circle 9a, a vector e₆ corresponding to “yellow-green” in the hue circle 9a, a vector e₇ corresponding to “green” in the hue circle 9a, a vector e₈ corresponding to “blue-green” in the hue circle 9a, a vector e₉ corresponding to “green-blue” in the hue circle 9a, a vector e₁₀ corresponding to “blue” in the hue circle 9a, a vector e₁₁ corresponding to “blue-violet” in the hue circle 9a, and a vector e₁₂ corresponding to “red-violet” in the hue circle 9a are defined as the oblique base vectors.

Consider the case where two image data items 9b and 9c which are to be compared are inputted. In the vector-set generation unit 3, correspondence relationships which indicate which color in the hue circle 9a is near to each color which the pixels constituting the image data items 9b and 9c can have are defined. Then, the vector-set generation unit 3 calculates the ratio of pixels having colors corresponding to each color in the hue circle 9a to the total number of pixels of each image represented by the image data items 9b and 9c. In the example of FIG. 2, the image represented by the image data item 9b is composed of a fifty-fifty mixture of red and green pixels, and the image represented by the image data item 9c is composed of a fifty-fifty mixture of red-orange and blue-green pixels.

The vector-set generation unit 3 generates vector sets 9d and 9e respectively corresponding to the image data items 9b and 9c. In the example of FIG. 2, the vector set 9d corresponding to the image data item 9b includes the vectors 0.5e₁ and 0.5e₇ as feature vectors, and the vector set 9e corresponding to the image data item 9c includes the vectors 0.5e₂ and 0.5e₈ as feature vectors.

Next, the vector-pair generation unit 4 generates a vector pair. For example, the vector-pair generation unit 4 acquires the feature vector 0.5e₁ from the vector set 9d, and then acquires the feature vector 0.5e₂ from the vector set 9e since the direction of the feature vector 0.5e₂ is nearest to the direction of the feature vector 0.5e₁. Then, the vector-pair generation unit 4 generates a vector pair of the two feature vectors acquired as above. Similarly, the vector-pair generation unit 4 generates another vector pair of the two feature vectors 0.5e₇ and 0.5e₈.

The vector-to-vector distance calculation unit 5 calculates a distance (d₁ and d₂) between feature vectors forming each vector pair generated by the vector-pair generation unit 4. The degree-of-similarity calculation unit 6 calculates a degree of similarity 9f by summing the distances d₁ and d₂.

As explained above, according to the present invention, a degree of similarity between multimedia-data items is determined by summing distances between respective vector pairs formed of feature vectors of multimedia-data items to be compared. Therefore, it is possible to efficiently calculate the degree of similarity without impairing discriminability between multimedia-data items.

In addition, since the features of multimedia-data items are represented by vectors, similar but different vectors can be easily discriminated based on the directions of the vectors, and processing load caused by generation of vector pairs is small.

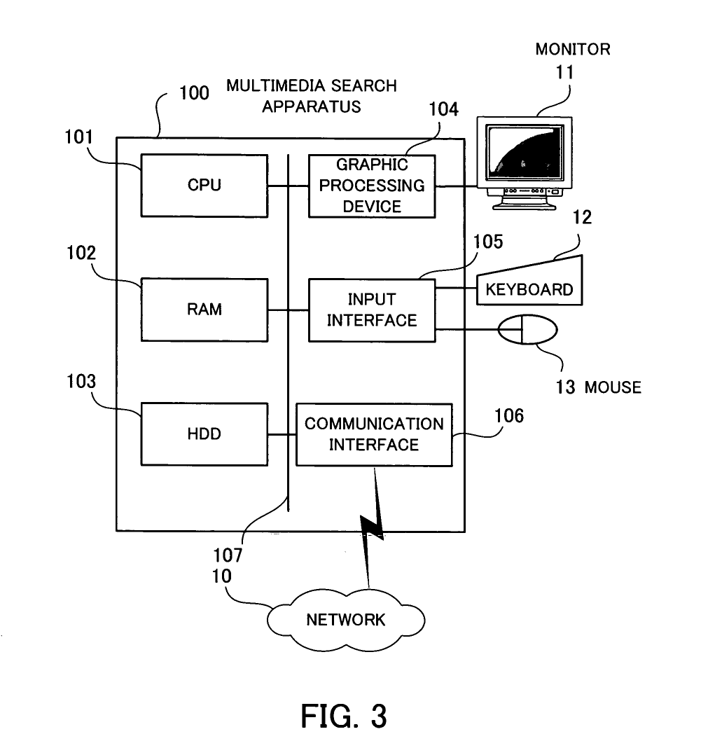

FIG. 3 is a diagram illustrating an example of a hardware construction of a multimedia-data search apparatus. The entire multimedia-data search apparatus 100 is controlled by a CPU (central processing unit) 101, to which a RAM (random access memory) 102, an HDD (hard disk drive) 103, a graphic processing device 104, an input interface 105, and a communication interface 106 are connected through a bus 107.

The RAM 102 temporarily stores at least portions of an OS (operating system) program and application programs which are executed by the CPU 101, as well as various types of data necessary for processing by the CPU 101. The HDD 103 stores the OS and application programs.

A monitor 11 is connected to the graphic processing device 104, which makes the monitor 11 display an image on a screen in accordance with an instruction from the CPU 101. A keyboard 12 and a mouse 13 are connected to the input interface 105, which transmits signals sent from the keyboard 12 and the mouse 13, to the CPU 101 through the bus 107.

The communication interface 106 is connected to a network 10, and exchanges data with other computers through the network 10.

By using the above hardware construction, it is possible to realize processing functions in the embodiment of the present invention.

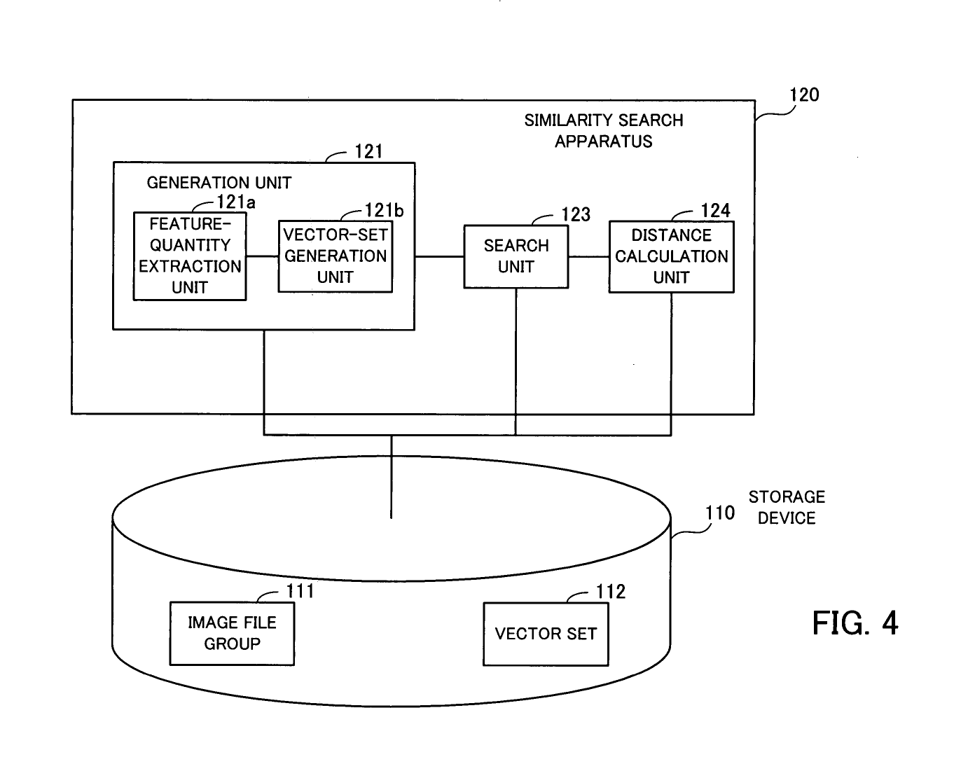

FIG. 4 is a diagram illustrating a function block diagram of the multimedia-data search apparatus. The functions of the multimedia-data search apparatus 100 can be broadly divided into a storage device 110 and a similarity search apparatus 120.

The storage device 110 stores an image file group 111 and vector sets 112. The image file group 111 includes a plurality of image data items to be compared, and is stored in the storage device 110 in advance of search operations. Each of the vector sets 112 is a set of feature vectors representing features of an image, and generated for each image data item which is included in the image file group 111.

The similarity search apparatus 120 comprises a generation unit 121, a search unit 123, and a distance calculation unit 124.

When an unprocessed image file is added to the image file group in the storage device 110, or when an image file as an object to be compared is passed from the search unit 123 to the generation unit 121, the generation unit 121 generates a vector set which represents the features of the image file. In the generation unit 121, a feature-quantity extraction unit 121a and a vector-set generation unit 121b perform operations for generation of the vector set.

The feature-quantity extraction unit 121a acquires an image file to be processed, and extracts a feature quantity of an image represented by the image file for each of prescribed representative features, which are, for example, predetermined colors. In the case where a feature quantity for each representative color is extracted, information indicating a designated color (representative color) similar to each of colors which can be represented in image files is predefined in the feature-quantity extraction unit 121a. Next, the feature-quantity extraction unit 121a classifies colors which are represented in each image file, into groups corresponding to the representative colors. Then, the feature-quantity extraction unit 121a determines the proportion of regions corresponding to each representative color in each image to be a feature quantity corresponding to the representative color (i.e., extracts the feature quantity), and temporarily stores the extracted feature quantity in the RAM 102.

The oblique base vectors are defined in advance in the vector-set generation unit 121b. The oblique base vectors are respectively defined in correspondence with the representative features, which correspond to feature quantities of image files. The vector-set generation unit 121b acquires from the RAM 102 the feature quantity extracted by the feature-quantity extraction unit 121a, multiplies the oblique base vector corresponding to the feature quantity by the feature quantity so as to produce a feature vector. When the production of the feature vectors for the respective feature quantities extracted by the feature-quantity extraction unit 121a is completed, the vector-set generation unit 121b generates a set of the feature vectors (i.e., a vector set).

When an image file to be processed is acquired from the storage device 110, the vector-set generation unit 121b stores the generated vector set 112 in association with the image file to be processed. When an image file to be processed is passed from the search unit 123, the vector-set generation unit 121b passes the generated vector set 112 to the search unit 123.

The search unit 123 receives input of an image file as an object to be compared, and searches the image file group 111 in the storage device 110 for an image file similar to the received image file. Specifically, the search unit 123 passes the received image file to the generation unit 121, and receives a vector set from the generation unit 121. Next, the search unit 123 sequentially receives from the generation unit 121 vector sets 112 respectively corresponding to image files in the storage device 110, and passes to the distance calculation unit 124 the vector set corresponding to the image file as the object to be compared and the vector sets 112 corresponding to image files in the storage device 110. Then, the distance calculation unit 124 calculates distances between the above vector sets, and passes the calculated distances to the search unit 123.

The search unit 123 recognizes the distances between the image files based on the vector set corresponding to the image file as the object to be compared and the vector sets corresponding to the respective image files in the storage device 110. The search unit 123 recognizes that image files less distant from (nearer to) the image file as the object to be compared are more similar to the image file as the object to be compared. Thus, the distance calculation unit 124 outputs as a search result a predetermined number of image files relatively less distant from the image file as the object to be compared (or identification information indicating the predetermined number of image files).

When the distance calculation unit 124 receives from the search unit 123 vector sets corresponding to two image files to be compared, the distance calculation unit 124 calculates the distance between the received image files. Specifically, the distance calculation unit 124 establishes one-to-one correspondences between feature vectors in the two inputted vector sets so as to form a plurality of vector pairs. The distance calculation unit 124 calculates distances between the respective vector pairs. Then, the distance calculation unit 124 calculates the sum of the distances between the respective vector pairs as a distance between the two vector sets, which is information indicating a degree of similarity between the two image files. The value indicating this distance decreases with increase in the degree of similarity. Finally, the distance calculation unit 124 passes the calculated distance to the search unit 123.

Thus, when an image file as an object to be compared is inputted into the above similarity search apparatus 120 by a user, the image file is passed from the search unit 123 to the generation unit 121. Then, the generation unit 121 generates a vector set of the image file passed from the search unit 123, and passes the generated vector set to the search unit 123. Subsequently, the search unit 123 extracts the vector sets 112 from the storage device 110, and the distance calculation unit 124 calculates distances between the generated vector set of the image file as the object to be compared and the extracted vector sets. Finally, the search unit 123 outputs as a similar image file an image file corresponding to one of the vector sets 112 which is nearest to the generated vector set of the image file as the object to be compared.

Hereinbelow, details of processing performed in the multimedia-data search apparatus 100 illustrated in FIG. 4 are explained.

1. Method for Obtaining Oblique Basis from Similarity Matrix

It is necessary to define an oblique basis in advance in the multimedia-data search apparatus 100. The oblique basis can be calculated based on a similarity matrix as indicated below.

In the following explanations, the term “square matrix” means a matrix in which the number of rows is equal to the number of columns, the term “regular matrix” means a matrix which has an inverse matrix, and the term “positive definite matrix” means a square matrix of which all eigenvalues are positive.

1.1 When Similarity Matrix is Positive Definite Matrix

Without losing generality, oblique base vectors e₁, e₂, e₃, . . . , eₙ constituting a requested oblique basis can be expressed as

$${e}_{1} = ( \begin{matrix}{e}_{11} \\ 0 \\ 0 \\ ⋮ \\ 0\end{matrix} ) , {e}_{2} = ( \begin{matrix}{e}_{12} \\ {e}_{22} \\ 0 \\ ⋮ \\ 0\end{matrix} ) , {e}_{3} = ( \begin{matrix}{e}_{13} \\ {e}_{23} \\ {e}_{33} \\ ⋮ \\ 0\end{matrix} ) , … {e}_{n} = ( \begin{matrix}{e}_{13} \\ {e}_{23} \\ {e}_{33} \\ ⋮ \\ {e}_{nn}\end{matrix} ) . \qquad ( 29 )$$

Therefore, a transformation matrix T from a vector having feature quantities as its elements to feature vectors is expressed as follows.

$$T = ( {e}_{1} , {e}_{2} , … , {e}_{n} ) = ( \begin{matrix}{e}_{11} & {e}_{12} & {e}_{13} & ⋯ & {e}_{1 n} \\ 0 & {e}_{22} & {e}_{23} & ⋯ & {e}_{2 n} \\ 0 & 0 & {e}_{33} & ⋯ & {e}_{3 n} \\ ⋯ & ⋯ & ⋯ & ⋯ & ⋯ \\ 0 & 0 & 0 & ⋯ & {e}_{nn}\end{matrix} ) \qquad ( 30 )$$

When a similarity matrix is expressed as

$$S = ( \begin{matrix}{s}_{11} & {s}_{12} & {s}_{13} & ⋯ & {s}_{1 n} \\ {s}_{21} & {s}_{22} & {s}_{23} & ⋯ & {s}_{2 n} \\ {s}_{31} & {s}_{32} & {s}_{33} & ⋯ & {s}_{3 n} \\ ⋯ & ⋯ & ⋯ & ⋯ & ⋯ \\ {s}_{n 1} & {s}_{n 2} & {s}_{n 3} & ⋯ & {s}_{nn}\end{matrix} ) , \qquad ( 31 )$$

the oblique basis should satisfy the following four conditions.
Condition C1: ∥e₁∥=1 (1<i≦n)
Condition C2: (eᵢ, eⱼ)=sᵢⱼ (1<i≦j≦n)
Condition C3: The oblique base vectors e₁, e₂, e₃, . . . , eₙ are linearly independent.
Condition C4: The degrees of similarity between objects represented by entire-feature vectors f=c₁e₁+c₂e₂+ . . . +cₙeₙ match the human color perception.

The left side of the equation of the condition C2 indicates an inner product of the oblique base vectors e_{i and e}ⱼ. However, the condition C3 is not a necessary condition for comparison of vector sets. That is, in the case where vector sets are compared, it is possible to achieve discriminability even when oblique base vectors which are not linearly independent of each other are used. However, when the oblique base vectors are linearly independent of each other, the discriminability is improved. Therefore, in this embodiment, oblique base vectors satisfying the condition C3 are used.

Since the condition C4 depends on human judgement, it is difficult to evaluate the condition C4. However, the ultimate goal of the similarity search is to satisfy the condition C4. On the other hand, the conditions C1 to C3 are mathematical, and it is possible to definitely determine whether or not the conditions C1 to C3 are satisfied. According to the method explained below, a solution which satisfies the conditions C1 to C3 is obtained while taking the condition C4 into consideration. First, a way of obtaining a solution which satisfies the conditions C1 to C3 is explained.

According to the condition C1, ∥e₁∥=1, i.e., e₁₁=1. In addition, according to the condition C2, the inner product of the oblique base vectors e₁ and eⱼ is determined as (e₁, eⱼ)=s₁ⱼ. Thus, the first row of the transformation matrix is determined.

Next, the second row is determined. First, since
∥e₂∥=\sqrt{e₁₂²+e₂₂²}=1 , (32)
e₂₂=\sqrt{1−e₂₂²}. (33)
Although more precisely
e₂₂=±\sqrt{1−e₁₂²} (34)
is derived from the equation (32), the positive sign is chosen in this specification since the condition C2 allows either of the positive and negative signs in the equation (32). Hereinafter, in every similar case, a positive sign will be chosen. Since the value of the element e₁₂ is already determined, it is possible to determine the value of the element e₂₂.

Subsequently, the values of the elements e₂ⱼ are obtained as follows.

Although
(e₂, eⱼ)=e₁₂e₁ⱼ+e₂₂e₂ⱼ=s₂ⱼ (35)
the values of the elements e₂ⱼ can be obtained by
e₂ⱼ=(s₂ⱼ−e₁₂e₁ⱼ)/e₂₂ (36)
since the value of the elements e₁₂, e₁ⱼ, and e₂₂ are already determined. It should be noted that e₂₂ must be nonzero as explained later. Hereinafter, It is assumed that e₂₂±0. Thus, the values of the elements eᵢⱼ for the other values of j can be sequentially obtained. Specifically, the following formulas are used.

$$\begin{matrix}{e}_{ij} = ( {s}_{ij} - {\sum }_{k = 1}^{i - 1} {e}_{ki} {e}_{kj} ) / {e}_{ii} & ( 37 ) \\ {e}_{ii} = \sqrt{1 - {\sum }_{k = 1}^{i - 1} {e}_{ki}^{2}} & ( 38 )\end{matrix}$$

Incidentally, the amount of data required to be stored is considered. When the oblique base vectors are obtained by calculation of only real numbers, and each real number is represented by w bytes, the amount of data required for representing a vector is wn bytes.

1.2 Introduction of Imaginary Number (When Similarity Matrix is Regular and Not Positive Definite)

In the above explanations, the case where the quantity in the square root in the right side of the formula (38) is equal to zero or negative is not mentioned.

(a) When the quantity in the square root in the right side of the formula (38) is zero, it is impossible to proceed calculation. This problem will be explained later in the next section, “1.3 When Similarity Matrix Is Not Regular.”

(b) When the quantity in the square root in the right side of the formula (38) is negative, the values of the elements eᵢᵢ become imaginary numbers. In this embodiment, the values of the elements eᵢᵢ are allowed to be imaginary numbers. Hereinbelow, a case where a value of an element eᵢᵢ becomes an imaginary number is indicated, and then a calculation method in the case where a value of an element eᵢᵢ is an imaginary number is explained.

First, it should be noted that the imaginary number is a pure imaginary number. In addition, when a value of an element eᵢᵢ is a pure imaginary number, all of the other elements eᵢⱼ satisfying i<j≦n in the same column become pure imaginary numbers. Therefore, all of the values of elements in each row in the matrix T are real numbers or pure imaginary numbers. For the sake of convenience, in this specification, each zero element in the matrix T is regarded as a real number or a pure imaginary number.

In addition, manners of definitions of the inner product, the length (norm) of each vector, and the distance between vectors are also important. Normally, the inner product and the length (norm) of vectors having components represented by complex numbers can be defined by using their complex conjugates. That is, when two vectors x and y are expressed as

$$x = ( \begin{matrix}{x}_{1} \\ {x}_{2} \\ ⋮ \\ {x}_{n}\end{matrix} ) , y = ( \begin{matrix}{y}_{1} \\ {y}_{2} \\ ⋮ \\ {y}_{n}\end{matrix} ) , and \qquad ( 39 )$$

yᵢ is a complex number expressed as a+bi, and \overline{yᵢ} is the complex conjugate a-bi of yᵢ, the inner product of the vectors can be defined as

$$( x , y ) = {\sum }_{i = 1}^{n} {x}_{i } \overline{{y}_{i}} , \qquad ( 40 )$$

where a and b are real numbers, and i is the imaginary unit. In addition, the length of the vector x can be defined as

$$‖ x ‖ = \sqrt{( x , x )} = {\sum }_{i = 1}^{n} {x}_{i } \overline{{x}_{i}} , and \qquad ( 41 )$$

the distance between the vectors x and y is expressed as

$${d ( x , y )}^{2} = {‖ x - y ‖}^{2} = {\sum }_{i = 1}^{n} ( {x}_{i } - {y}_{i} ) \overline{( {x}_{i } - {y}_{i} )} . \qquad ( 42 )$$

According to the above definition, the length of every vector is guaranteed to be zero or positive. However, the above definition is not used in the present embodiment, and instead the inner product of the vectors x and y is defined as

$$( x , y ) = {\sum }_{i = 1}^{n} {x}_{i } {y}_{i} . \qquad ( 43 )$$

That is, in the present embodiment, the inner product of vectors having elements represented by complex numbers is defined as the inner product of vectors having elements represented by real numbers. Therefore, the length of each vector and the distance between two vectors are defined as

$$\begin{matrix}‖ x ‖ = \sqrt{( x , x )} = {\sum }_{i = 1}^{n} {x}_{i }^{2} , and & ( 44 ) \\ {d ( x , y )}^{2} = {‖ x - y ‖}^{2} = {\sum }_{i = 1}^{n} {( {x}_{i } - {y}_{i} )}^{2} . & ( 45 )\end{matrix}$$

The reason why the above definitions are used is that in some of the cases where the distances are defined by using the complex conjugates, it is impossible to concurrently satisfy both of the conditions C1 and C2. On the other hand, when the distances are defined as in the present embodiment, it is possible to concurrently satisfy both of the conditions C1 and C2. The definitions of the distances as in the present embodiment are used for defining the space-time intervals in the special theory of relativity.

In the present embodiment, according to the above definitions, it is possible to obtain a solution which concurrently satisfies all of the conditions C1, C2, and C3 when the values of the elements e₁₁ are nonzero.

<Example in which Imaginary Element Appears (First Example)>

Hereinbelow, an example where an imaginary element occurs is indicated below as a first example. In the following explanation, the Munsell color solid and in particular, black, white, and grey in the Munsell color solid are considered.

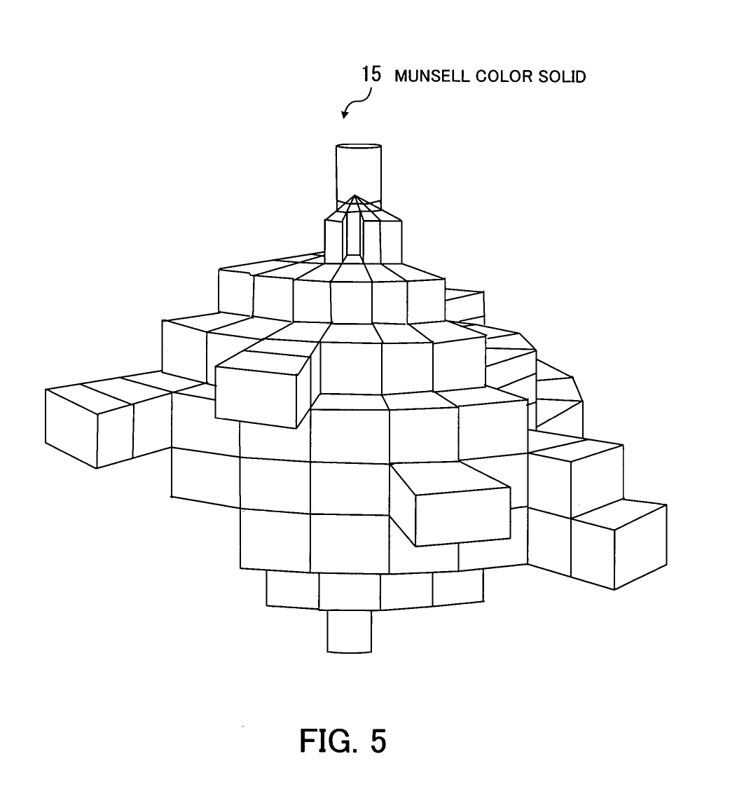

FIG. 5 is a diagram illustrating the Munsell color solid. In the Munsell color solid 15, the pure colors appearing in the hue circle and other colors are three-dimensionally arranged, and similarity between the colors is indicated by the distances between the colors.

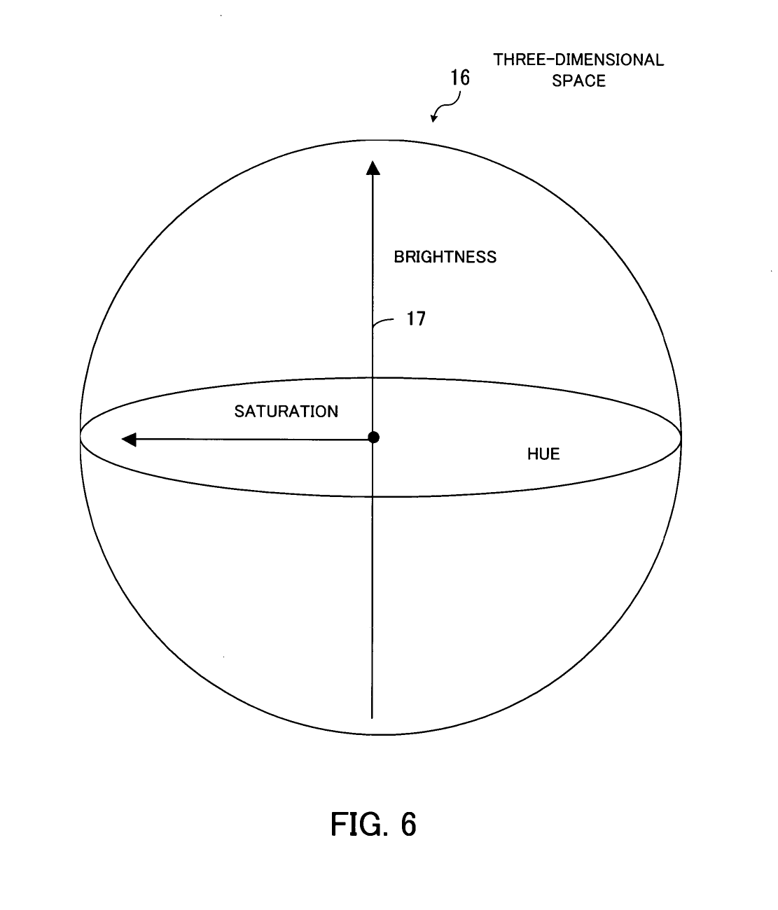

FIG. 6 is a diagram illustrating a relationship among the hue, the brightness (lightness), and the saturation (chroma), which are three properties of the color. In FIG. 6, the brightness is indicated by the elevation in the three-dimensional space 16, the saturation is indicated by the distance from the vertical axis 17, and the hue is indicated by the orientation around the vertical axis 17.

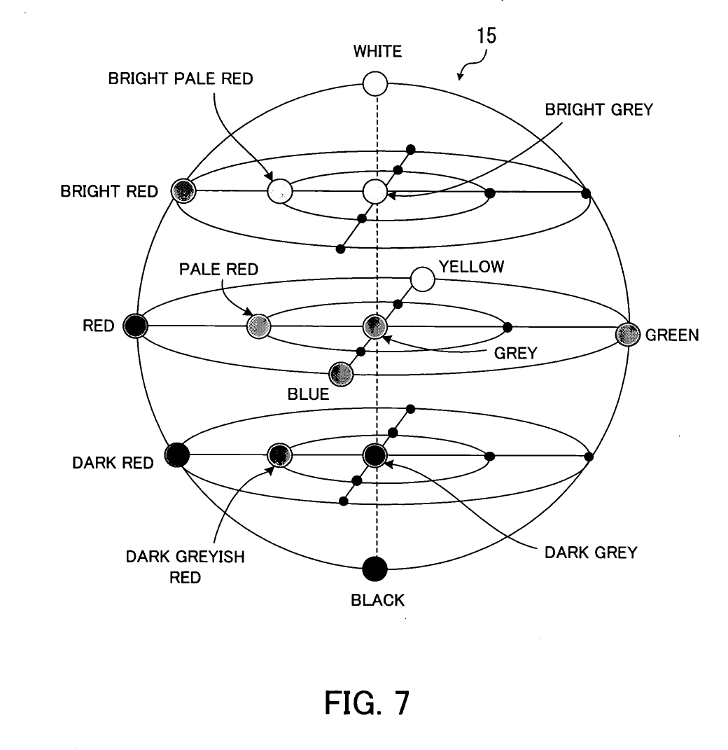

FIG. 7 is a diagram briefly illustrating an arrangement of colors on the Munsell color solid. When the Munsell color solid 15 is compared to the earth, white corresponds to the north pole, black corresponds to the south pole, and grey corresponds to the center of the earth. That is, white, grey, and black are arranged on a straight line. When black and white are completely independent features, oblique base vectors corresponding to black and white can be considered to be perpendicular to each other. That is, the distance between the oblique base vectors corresponding to black and white can be considered to be 2^{1/2}. At this time, each of the distance between grey and black and the distance between grey and white can be considered to be 2^{1/2}/2. In this case, a similarity matrix in which the above distances are directly reflected is expressed as

$$S = ( \begin{matrix}1 & \frac{3}{4} & 0 \\ \frac{3}{4} & 1 & \frac{3}{4} \\ 0 & \frac{3}{4} & 1\end{matrix} ) , and \qquad ( 46 )$$

the oblique base vectors corresponding to the similarity matrix are expressed as

$${e}_{1} = ( \begin{matrix}1 \\ 0 \\ 0\end{matrix} ) , {e}_{2} = ( \begin{matrix}\frac{3}{4} \\ \frac{\sqrt{7}}{4} \\ 0\end{matrix} ) , {e}_{3} = ( \begin{matrix}0 \\ \frac{3 \sqrt{7}}{7} \\ \frac{\sqrt{14}}{7} i\end{matrix} ) . \qquad ( 47 )$$

That is, a pure imaginary number appears in the oblique base vector e₃, i.e., the third component of the oblique base vector e₃ is a pure imaginary number.

The amount of data required to be stored in the case where the similarity matrixes can have an element represented by a pure imaginary number is indicated below.

As mentioned before, in the case where all of the elements of the similarity matrixes are represented by real numbers, and each real number is represented by w bytes, the amount of data required for representing a vector is wn bytes. Normally, the amount of data required for representing a vector represented by complex numbers is twice the amount of data required for representing a vector represented by real numbers, i.e., 2wn bytes. However, in the method used in this embodiment, the imaginary numbers are pure imaginary numbers, and the row or rows in which imaginary numbers appear are fixed. Therefore, in this embodiment, only the information indicating the row or rows in which imaginary numbers appear is stored separately from vectors. Thus, the substantial amount of data required for representing a vector is still wn bytes, as in the case where the similarity matrixes are positive definite.

The J.S.N. Jean reference discloses that when the feature vectors obtained by the transformation are represented by real numbers, the amount of data required for representing a each feature vector is wn bytes. In addition, as explained above, even in the more generalized case where the components of feature vectors obtained by a similarity matrix may be pure imaginary numbers, the substantial amount of data required for representing each feature vector is still wn bytes.

1.3 When Similarity Matrix is not Regular

Hereinbelow, a method which enables acquisition of a solution even in the case where an element eᵢᵢ is zero is explained. In this method, it is assumed that the dimension of the oblique base vectors is 2n, and the oblique base vectors are expressed as

$${e}_{1} = ( \begin{matrix}{e}_{11} \\ 0 \\ 0 \\ ⋮ \\ 0 \\ {e}_{n + 1 , {1}^{i}} \\ 0 \\ 0 \\ ⋮ \\ 0\end{matrix} ) , {e}_{2} = ( \begin{matrix}{e}_{11} \\ {e}_{22} \\ 0 \\ ⋮ \\ 0 \\ 0 \\ {e}_{n + 2 , {2}^{i}} \\ 0 \\ ⋮ \\ 0\end{matrix} ) , {e}_{3} = ( \begin{matrix}{e}_{11} \\ {e}_{23} \\ {e}_{33} \\ ⋮ \\ 0 \\ 0 \\ 0 \\ {e}_{n + 3 , {3}^{i}} \\ ⋮ \\ 0\end{matrix} ) , {⋯e}_{n} = ( \begin{matrix}{e}_{1 n} \\ {e}_{2 n} \\ {e}_{3 n} \\ ⋮ \\ {e}_{nn} \\ 0 \\ 0 \\ 0 \\ ⋮ \\ {e}_{2 n , {n}^{i}}\end{matrix} ) . \qquad ( 48 )$$

In addition, each of the components eᵢᵢ (1≦i≦n) is initially assumed to be one, i.e., eᵢᵢ=1 (1≦i≦n). Therefore, each of the components eᵢᵢ (1≦i≦n) is not zero. In this case, the length of each oblique base vector seems to exceed one, and not to satisfy the condition C1. However, the components eₙ₊ᵢ, i in the (n+1)st to 2nth rows adjust for the above excess. The values of these components eᵢⱼ can be obtained in a similar manner to those explained in the previous sections 1.1 and 1.2.

The amount of data required to be stored in the case of 2n dimensions is indicated below.

In the case of n dimensions, as explained before, even in the case where imaginary numbers are introduced, the substantial amount of data required for representing each feature vector is wn bytes when each real number is represented by w bytes. On the other hand, in the case of 2n dimensions, the vector components corresponding to the (n+1)st to 2nth dimensions are pure imaginary numbers. Therefore, it is unnecessary to use complex numbers as in the case of n dimensions, and vectors can be substantially represented by 2n real numbers. Therefore, the amount of data required to be stored in the case of 2n dimensions is 2nw bytes, i.e., doubled compared with the case of n dimensions.

When the above method using 2n dimensions is used, although the amount of data required to be stored increases, it is possible to obtain oblique base vectors in every case regardless of regularity of the similarity matrix.

Further, it is possible to reduce the amount of data required to be stored, by combining the above method explained in this section and the method explained in the previous section 1.2, as indicated in the following section 1.4.

1.4 Reduction of Dimension

In the method explained below, the methods explained in the previous sections 1.2 and 1.3 are combined for reduction of the dimension. The methods explained in this section are classified into a first method in which importance is placed on the method of sections 1.2 and a second method in which importance is placed on the method of sections 1.3. Hereinafter, the first method is referred to as the minimum dimension method since the dimension can be minimized according to the first method, and the second method is referred to as the separation method since, according to the second method, components represented by imaginary numbers are separately arranged in the (n+1)st and subsequent rows.

Sequences of the first and second methods are indicated below. Since the first and second methods are different in only portions of their sequences, the common portions of the sequences of the first and second methods are commonly explained below. In addition, in the following explanations, an array defined for memorizing integers is indicated by a.
1) Initially, m is set to one (i.e., m=1), where m is an integer for counting dimensions.
2) The following processing is performed for i=1, 2, . . . , n.
In the case where i<j, the values of the elements eᵢⱼ are obtained by the method explained in section 1.2.
The values of the elements eᵢᵢ are obtained in different ways depending on which of the minimum dimension method and the separation method is used.
i) According to the minimum dimension method, the method explained in section 1.2 is used when eᵢⱼ≠0. When eᵢᵢ=0, the value of the element eᵢᵢ is set to one (i.e., eᵢᵢ=1), m is incremented by one (i.e., m=m+1), and the value of i is stored as a[m]=i.
ii) In the separation method, the values of the elements eᵢᵢ are obtained in different ways depending on the value of

$$s = {\sum }_{k = 1}^{i - 1} {e}_{ki}^{2} . \qquad ( 49 )$$
When s>0, the value of the element eᵢᵢ is set to (1−s)^{1/2}, i.e., eᵢᵢ=(1−s)^{1/2}. When s≦0, as in the minimum dimension method, the value of the element eᵢᵢ is set to one, i.e., eᵢᵢ=1, m is incremented by one, i.e., m=m+1, and the value of i is stored as a[m]=i.
3) In the case where m>0, the following processing is performed.

The dimension of the oblique base vectors is determined to be n+m, and the values of the matrix elements for k=1, 2, . . . , m are calculated based on the following formulas, where i=a[k].

$$\begin{matrix}{e}_{n + k , k} = {\sum }_{j = 1}^{i - 1} {e}_{ij}^{2} & ( 50 ) \\ {e}_{n + i , k} = 0 ( 1 \leq i \leq m , i \neq k ) & ( 51 )\end{matrix}$$

The vector components corresponding to 1st to nth dimensions are real numbers, and the vector components corresponding to (n+1)st to (n+m)th dimensions are pure imaginary numbers. Thus, the oblique base vectors can be expressed as follows. First, each oblique base vector which has no imaginary component is expressed as follows.

$${e}_{i} = ( \begin{matrix}{e}_{1 i} \\ {e}_{2 i} \\ ⋮ \\ {e}_{i i} \\ 0 \\ ⋮ \\ 0\end{matrix} ) \qquad ( 52 )$$

In addition, each oblique base vector which has at least one imaginary component is expressed as follows.

$${e}_{i} = ( \begin{matrix}{e}_{1 i} \\ {e}_{2 i} \\ ⋮ \\ {e}_{i - 1 , i} \\ 1 \\ 0 \\ ⋮ \\ 0 \\ {e}_{n + i , i} ⅈ \\ 0 \\ ⋮ \\ 0\end{matrix} ) \qquad ( 53 )$$

As explained above, when the number of oblique base vectors is n (where n is an integer), and the oblique base vectors are not linearly independent within n dimensions, it is possible to realize linear independency by defining oblique base vectors with a dimension in the range from n+1 to 2n. When the above method for dimension reduction is used, the amount of data required to be stored is as small as (n+m)w bytes.

2. Measure for Overcoming Lack of Discriminability

A measure for overcoming the aforementioned lack of discriminability is explained below. This problem does not occur in the method using the orthogonal basis and the Euclidean distance, since, according to the method using the orthogonal basis and the Euclidean distance, the distance between two different objects is necessarily positive, i.e., nonzero. However, in the method using the orthogonal basis and the quadratic-form distance and in the method using the oblique basis and the Euclidean distance, in some cases, vectors corresponding to two different objects become identical, or distances between different vectors become zero. The former problem occurs since the oblique base vectors are not linearly independent of each other, and the latter problem can occur when an imaginary number appears in the aforementioned solution.

Hereinbelow, attempts are made to solve the above problem by the following two approaches:
(a) An approach using deformation of a similarity matrix
(b) An approach using a multivector distance

The basic concept of the approach (a) is to bring the similarity matrix obtained as above close to a unit matrix. In addition, in the approach (b), a solution is sought without deforming the similarity matrix.

2.1 Loss of Discriminability

Hereinbelow, two simple examples in which discriminability is lost are indicated.

### <Examples of Linearly Dependent Vectors (Second Example)>

Consider four colors, red, yellow, green, and blue out of the colors in the hue circle, and assume that the four colors are located at the quartering points of the hue circle. At this time, a similarity matrix in which the distances between the four colors in the hue circle are directly reflected is expressed as

$$S = ( \begin{matrix}1 & \frac{1}{2} & 0 & \frac{1}{2} \\ \frac{1}{2} & 1 & \frac{1}{2} & 0 \\ 0 & \frac{1}{2} & 1 & \frac{1}{2} \\ \frac{1}{2} & 0 & \frac{1}{2} & 1\end{matrix} ) . \qquad ( 54 )$$

In addition, the following vectors are oblique base vectors corresponding to the above similarity matrix.

$${e}_{1} = ( \begin{matrix}1 \\ 0 \\ 0 \\ 0\end{matrix} ) , {e}_{2} = ( \begin{matrix}\frac{1}{2} \\ \frac{\sqrt{3}}{2} \\ 0 \\ 0\end{matrix} ) , {e}_{3} = ( \begin{matrix}0 \\ \frac{\sqrt{3}}{3} \\ \frac{\sqrt{6}}{3} \\ 0\end{matrix} ) , {e}_{n} = ( \begin{matrix}\frac{1}{2} \\ - \frac{\sqrt{3}}{6} \\ \frac{\sqrt{6}}{3} \\ 0\end{matrix} ) \qquad ( 55 )$$

However, actually the above oblique base vectors are not linearly independent. Therefore, mathematically, the vectors e₁, e₂, e₃, and e₄ (55) should not be called base vectors. For example, when the set of vectors (55) are used, the feature vector f₁ of an image composed of 50% of red pixels and 50% of green pixels (i.e., pixels of complementary colors) and the feature vector f₂ of an image composed of 50% of yellow pixels and 50% of blue pixels are each a zero vector as indicated below, since the pair of red and green and the pair of yellow and blue are each a pair of complementary colors.

$$\begin{matrix}{f}_{1} = 0.5 {e}_{1} + 0.5 {e}_{3} = ( \begin{matrix}0 \\ 0 \\ 0 \\ 0\end{matrix} ) & ( 56 ) \\ {f}_{2} = 0.5 {e}_{2} + 0.5 {e}_{4} = ( \begin{matrix}0 \\ 0 \\ 0 \\ 0\end{matrix} ) & ( 57 )\end{matrix}$$

This is because the set of vectors e₁, e₂, e₃, and e₄ (55) are not linearly independent.

<Example of Linearly Independent Vectors which Lack Discriminability (Third Example)>

Consider again the aforementioned example of white, black, and grey, which is used for explaining occurrence of an imaginary number. In this case, by using the aforementioned vectors

$${e}_{1} = ( \begin{matrix}1 \\ 0 \\ 0\end{matrix} ) , {e}_{2} = ( \begin{matrix}\frac{3}{4} \\ \frac{\sqrt{7}}{4} \\ 0\end{matrix} ) , {e}_{3} = ( \begin{matrix}0 \\ \frac{3 \sqrt{7}}{7} \\ \frac{\sqrt{14}}{7} ⅈ\end{matrix} ) , \qquad ( 58 )$$

the feature vector f₁ of an image composed of 50% of white pixels and 50% of black pixels and the feature vector f₂ of an image composed of only grey pixels are respectively expressed as

$$\begin{matrix}{f}_{1} = 0.5 {e}_{1} + 0.5 {e}_{3} = ( \begin{matrix}\frac{1}{2} \\ \frac{3 \sqrt{7}}{14} \\ \frac{\sqrt{14}}{14} ⅈ\end{matrix} ) , and & ( 59 ) \\ {f}_{2} = {e}_{2} = ( \begin{matrix}\frac{3}{4} \\ \frac{\sqrt{7}}{4} \\ 0\end{matrix} ) . & ( 60 )\end{matrix}$$

The distance between the above two feature vectors is calculated to be zero, i.e., d(f₁, f₂)²=0. That is, although the vectors e₁, e₂, and e₃ are linearly independent, the vectors e₁, e₂, and e₃ lack discriminability.

The lack of discriminability is a serious problem. This problem does not occur in the method using the orthogonal basis and the Euclidean distance since the base vectors in the orthogonal basis are linearly independent, and the Euclidean distance satisfies the distance axiom. Actually, when the base vectors are linearly independent, different objects correspond to different vectors. In addition, the distance between different vectors is nonzero.

One of the following causes is considered to lead to the lack of discriminability in the aforementioned third example:
(R1) Wrong setting of the similarity matrix
(R2) Limitations of the quadratic-form distance per se

Next, an attempt to overcome the lack of discriminability is made from the viewpoint of each of the above causes (R1) and (R2).

First, an attempt to overcome the above problem within the framework of the quadratic-form distance (i.e., by modification of the similarity matrix) is made from the viewpoint of the cause (R1).

It is considered that there is a trade-off relationship between discriminability and similarity between features. Actually, the method using the orthogonal basis and the Euclidean distance is included in the method using the oblique basis and Euclidean distance and the method using the quadratic-form distance, and the similarity matrix in the method using the orthogonal basis and the Euclidean distance is a unit matrix. Therefore, when the similarity matrix is brought closer to a unit matrix, the method using the quadratic-form distance can be brought closer to the method using the orthogonal basis and the Euclidean distance, which does not have the problem of lack of discriminability. At this time, the value “one” of the elements sᵢᵢ in the similarity matrix is unchanged. In addition, the other elements sᵢⱼ are reduced by multiplying sᵢⱼ by a real number a satisfying 0≦a≦1. Thus, the similarity matrix is brought closer to a unit matrix. That is, the real number a is a parameter for controlling the degree of proximity to the unit matrix. When a=1, the matrix is the unchanged similarity matrix. When a=0, the method using the quadratic-form distance becomes the method using the orthogonal basis and the Euclidean distance. Hereinafter, the above method for bringing the similarity matrix closer to a unit matrix is referred to as the similarity-matrix deformation method.

2.2 Loss of Similarity

The similarity between features are maintained in the method using the quadratic-form distance and the method using the oblique basis and the Euclidean distance. In other words, when objects each have only a single feature, the similarity between the objects is maintained. However, in some cases, similarity between nonzero feature vectors each of which represents a plurality of feature quantities is lost. This problem is considered in this section. First, a simple example in which the above problem occurs is indicated below.

<Example in which Similarity is Lost (Fourth Example)>

A hue circle comprised of twelve colors is considered. In the following explanations, when an image composed of pixels of a pair of complementary colors Color1 and Color2, and the amounts of the pixels of each color is identical, the image is denoted Color1+Color2. For example, according to the human color perception, the red+green images look more similar to the (red-orange)+green images than to the yellow+blue images. However, according to the method using the oblique basis and the Euclidean distance or the method using the quadratic-form distance, the degrees of similarity between the above images cannot be determined as the human beings perceive, by simply deforming the similarity matrix based on the aforementioned single parameter a, and instead all of the above images are determined to be similar.

The above fact is explained in detail below. Assume that the colors correspond to twelve points which equally divide the hue circle into twelve portions, as in the aforementioned first example, in which an imaginary element appears. When entire-feature vectors each corresponding to an image composed of identical amounts of pixels of a pair of complementary colors are expressed as
fᵢ=0.5eᵢ+0.5eᵢ₊₆(1≦i≦6), (61)
relationships between the distances d(f₁, fⱼ) (1≦i, j<6) and the parameter a are considered below.

The applicants had expected the similarity between features to be reflected in the distance between the feature vectors fᵢ and fⱼ, i.e., the following relationships exist.
d(f₁, f₂)<d(f₁, f₃)<d(f₁, f₄)<d(f₁, f₅) (62)
In addition, the applicants had also expected the differences between the above four distances to be greater when the parameter a is closer to one within the range of 0<a≦1, while the above distances in the relationships (62) are identical when a=0 (i.e., in the method using the orthogonal basis and the Euclidean distance).

However, the applicants actually calculated the above distances for various values of the parameter a, and found that the following relationships exist regardless of the value of the parameter a.
d(f₁, f₂)=d(f₁, f₃)=d(f₁, f₄)=d(f₁, f₅) (63)
That is, the same relationships as the relationships in the method using the orthogonal basis and the Euclidean distance exist even in the methods using the quadratic-form distance or the method using the orthogonal basis and the Euclidean distance. The above relationships indicate that the similarity between features is lost, and remains lost even when the parameter a is brought closer to zero.

In the case where the similarity is lost as in the above fourth example, the matrix is deformed by using a plurality of parameters. Thereby, the problem of the loss of similarity between features as in the fourth example is overcome.

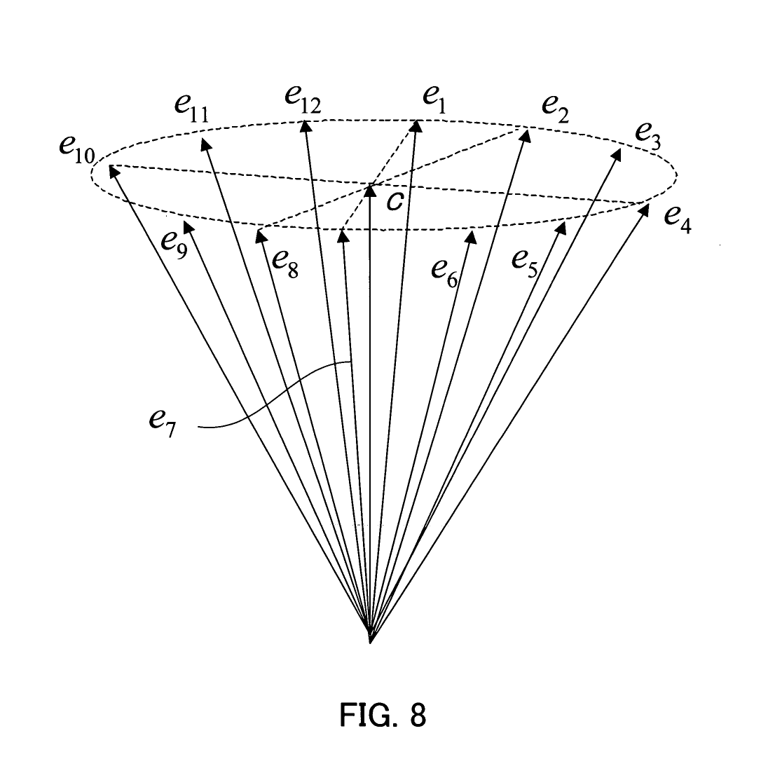

FIG. 8 is a diagram illustrating an oblique basis in the case where a=1. In this case, the aforementioned entire-feature vectors fi (defined by the formula (61)) for all values of i (1≦i<6) become identical to a vector c corresponding to the center of the hue circle. Since the distances become zero, the discriminability and the similarity between features are lost. Although each vector fᵢ in the formula (61) is a vector generated by synthesis of the two vectors 0.5eᵢ and 0.5eᵢ₊₆, when attention is focused on line segments indicating the two vectors 0.5eᵢ and 0.5eᵢ₊6, the similarity is maintained in these line segments. The polyhedral distance (distance between vector sets) which is used in this embodiment is based on the above fact.

2.3 Feature Space Based on Distances Between Vector Sets (Multivector Feature Space)

In this section, a method for solving a problem of the loss of discriminability and similarity based on an assumption that the aforementioned cause (R2) leads to the problem is explained.

The discriminability and similarity are lost in the case where feature vectors are synthesized from oblique base vectors as indicated in the fourth example. However, attention is focused on unsynthesized nonzero vectors (i.e., vectors cᵢeᵢ (1≦i≦n), where cᵢ≠0), these vectors hold information on feature quantities and information on similarity between features. In addition, discriminability is not lost.

Consider a set of vectors
F={cᵢeᵢ|1≦i≦n, cᵢ≠0}. (64)
In this specification, a set of vectors as indicated in (64) are referred to as a vector set. Each vector set may redundantly include identical vectors. In this sense, to be more precise, the vector set is a multiset (multivector).

Hereinbelow, in order to facilitate conceptual understanding of effectiveness of use of vector sets, values of vectors are replaced with material points in the following explanations. In multivector spaces, each object is generally represented by a plurality of vectors. It is assumed that a material point having an identical mass is placed at a point corresponding to each of a plurality of vectors. At this time, it is possible to consider a kind of solid formed of these material points. The δ-distance defined in the following explanations is a definition of a distance between solids each of which is formed as above. In this case, an approximation to a feature set is produced by dividing material points forming each solid into a plurality of groups, and replacing each group with (an essential equivalent to) a center of gravity.

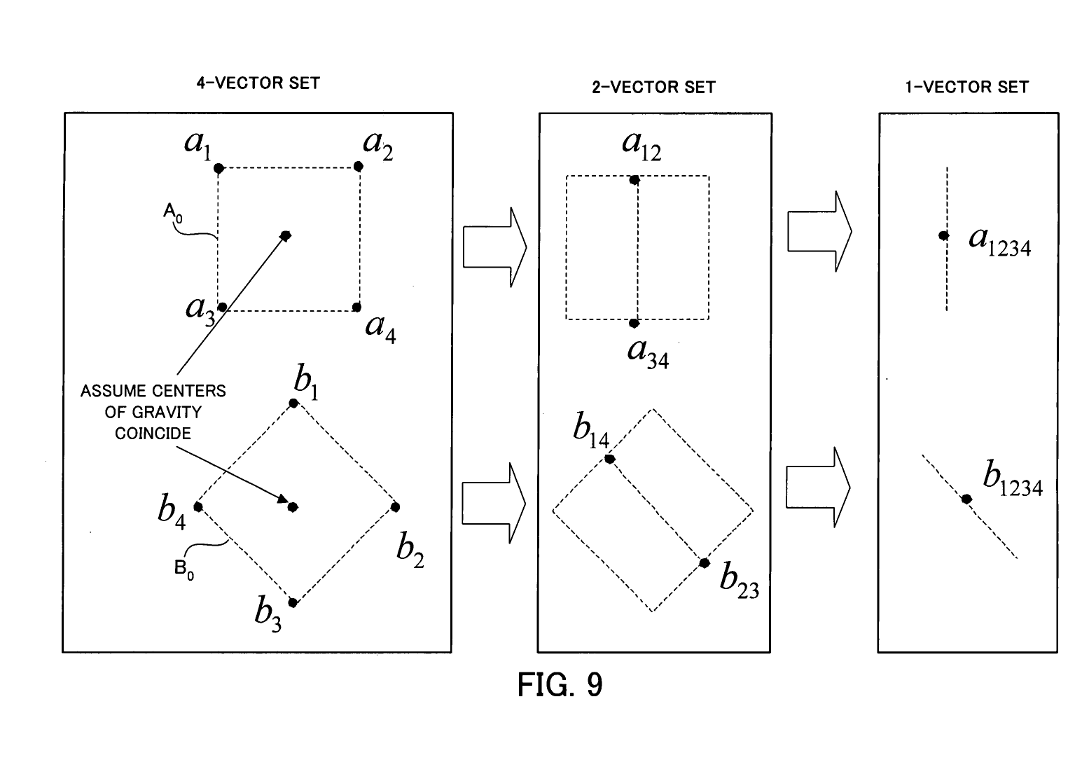

FIG. 9 is a diagram illustrating two vector sets to be compared. FIG. 9 shows two solids corresponding to the two vector sets A₀=(a₁, a₂, a₃, a₄) and B₀=(b₁, b₂, b₃, b₄). It is assumed that a material point having an identical mass is placed at each of a plurality of vertexes. This assumption is considered to be valid at least in the case of a feature set, although the examples illustrated in FIG. 9 are not feature sets. Although, generally, the centers of gravity of two solids do not coincide, the centers of gravity of the two solids in the example of FIG. 9 are assumed to coincide. Then, each of the solids which is formed of the four material points is approximated by a solid formed of two points corresponding to the centers of gravity. The two points in the first solid are respectively determined as
a₁₂=a₁+a₂, and
a₃₄=a₃+a₄,
where aᵢⱼ is the center of gravity of the material points aᵢ and aⱼ. In addition, the points in the second solid are respectively determined as
b₁₄=b₁+b₄, and
b₂₃=b₂+b₃,
where bᵢⱼis the center of gravity of the material points bᵢ and bⱼ. Although, to be more precise, the right side of each of the above four definitions of the centers of gravity should be divided by two, aᵢⱼ and bᵢⱼ are each referred to as a center of gravity in this specification since the essence is unchanged except for the factor of ½.

Further, the centers of gravity of the above centers of gravity aᵢⱼ and bᵢⱼ are respectively determined as
a₁₂₃₄=a₁₂+a₃₄=a₁+a₂+a₃+a₄, and
b₁₂₃₄=b₁₂+b₃₄=b₁+b₂+b₃+b₄.

Thus, the original, first and second solids are respectively approximated by their centers of gravity. Since the centers of gravity of the first and second solids are assumed to coincide, the points a₁₂₃₄ and b₁₂₃₄ coincide. This means that discriminability is lost.

Therefore, according to the present embodiment, vectors in each vector set in a multivector feature space are not synthesized, and the concept of the distance between solids is defined by one-to-one comparison of individual vectors. The basic concept is to define a distance between vector sets in order to measure a degree of similarity between the vector sets. Although the distance can be defined in various manners, two basic examples are indicated below.

<Example of Calculation of Distance between Multivectors (Fifth Example)>

First, the situation of the aforementioned fourth example, in which the similarity is lost according to the conventional method, is considered below.

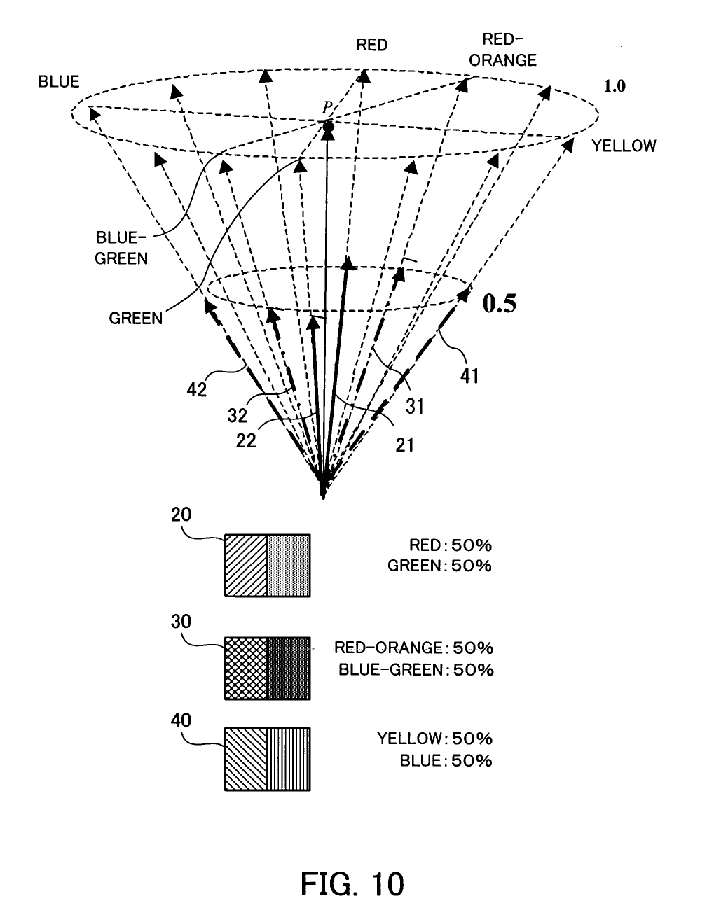

FIG. 10 is a diagram illustrating examples of vector sets in a multivector feature space. As illustrated in FIG. 10, a distance between an image 20 composed of 50% of red pixels and 50% of green pixels and an image 30 composed of 50% of red-orange pixels and 50% of blue-green pixels and a distance between the image 20 and an image 40 composed 50% of yellow pixels and 50% of blue pixels are calculated. For this purpose, first, multivector sets representing features of the respective images 20, 30, and 40 are generated.

A first multivector set for the image 20 includes a vector 21 being oriented in the direction of red and having a length of 0.5 and a vector 22 being oriented in the direction of green and having a length of 0.5. A second multivector set for the image 30 includes a vector 31 being oriented in the direction of red-orange and having a length of 0.5 and a vector 32 being oriented in the direction of blue-green and having a length of 0.5. A third multivector set for the image 40 includes a vector 41 being oriented in the direction of yellow and having a length of 0.5 and a vector 42 being oriented in the direction of blue and having a length of 0.5.

Then, multivector sets are defined as follows.
Fᵢ={0.5eᵢ, 0.5eᵢ₊₆}(1≦i<6). (65)
In addition, the δ-distance between the multivector sets Fᵢ and Fⱼ (i≦j) are defined as

$$δ ( {F}_{i} , {F}_{j} ) = {min}_{μ ∈ M} {\sum }_{v ∈ {F}_{i}} d ( v , μ ( v ) ) , \qquad ( 66 )$$

where M is a set containing all of one-to-one mappings from vectors in the multivector set Fᵢ to vectors in the multivector set Fⱼ, and each of the multivector sets Fᵢ and Fⱼ contains m vectors. In this example, the δ-distance can be expressed as
δ(Fᵢ, Fᵢ₊ⱼ)=2\sqrt{1−|cos(πj/6)|}, (67)
where 1≦j<6, and |cos(πj/6)| is an absolute value of cos(πj/6). Therefore, δ (F₁, F₂)=0.732, δ (F₁, F₃)=1.414, δ (F₁, F₄)=2, δ (F₁, F₅)=1.414, and δ (F₁, F₆)=0.732. That is, the discriminability is maintained, and the problem of the loss of similarity is also solved. In addition, the similarity between features is natural.

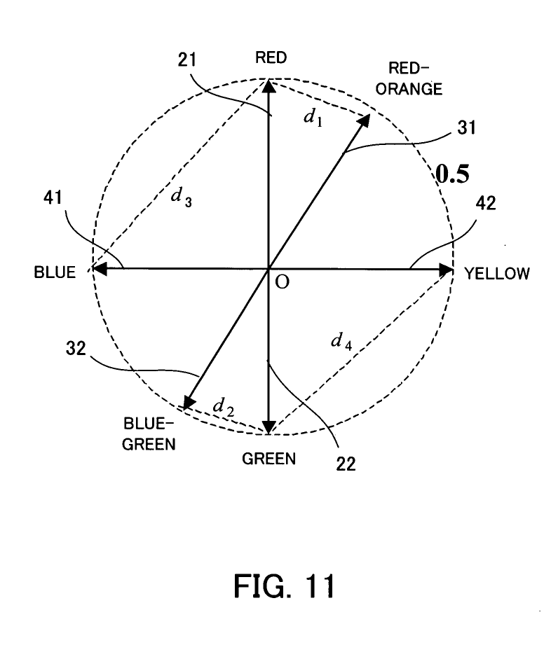

FIG. 11 is a diagram illustrating examples of multivector distances between images. FIG. 11 shows a multivector distance between the images 20 and 30 illustrated in FIG. 10 and a multivector distance between the images 20 and 40 illustrated in FIG. 10.

In order to calculate the δ-distance between the images 20 and 30, first, a distance d₁ between the vector 21 included in the multivector set for the image 20 and the vector 31 included in the multivector set for the image 30 is calculated. Similarly, a distance d₂ between the vector 22 included in the multivector set for the image 20 and the vector 32 included in the multivector set for the image 30 is calculated. Thus, the δ-distance between the images 20 and 30 is obtained by calculating a sum of the distances d₁ and d₂.

In order to calculate the δ-distance between the images 20 and 40, first, a distance d₃ between the vector 21 included in the multivector set for the image 20 and the vector 41 included in the multivector set for the image 40 is calculated. Similarly, a distance d₄ between the vector 22 included in the multivector set for the image 20 and the vector 42 included in the multivector set for the image 40 is calculated. Thus, the δ-distance between the images 20 and 40 is obtained by calculating a sum of the distances d₃ and d₄.

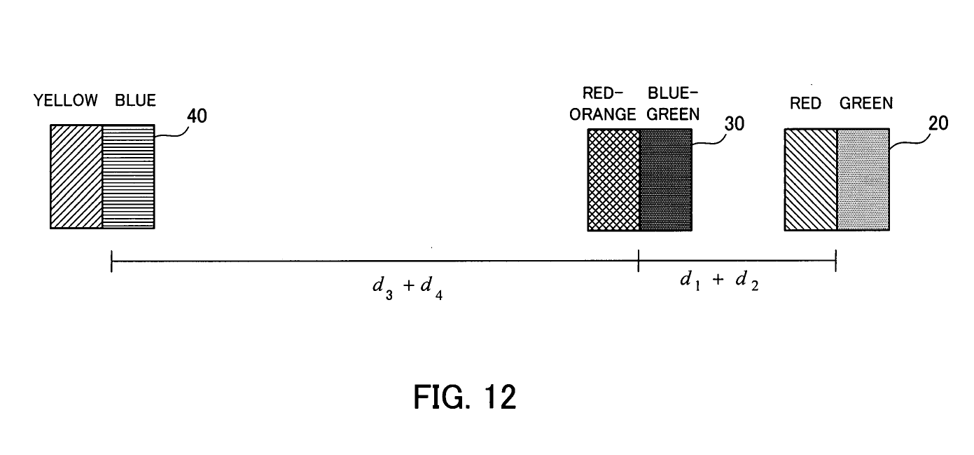

FIG. 12 is a diagram illustrating the δ-distances between images by using the above multivector distances. As illustrated in FIG. 12, the δ-distance between the images 20 and 30 is smaller than the δ-distance between the images 20 and 40. Therefore, when an image similar to the image 20 is searched for, the image 30 is detected with a higher priority than the image 40.

<Provision for Linearly Dependent Vectors (Sixth Example)>

Next, a provision for the situation of the aforementioned second example, in which the vectors are not linearly independent, is considered below.

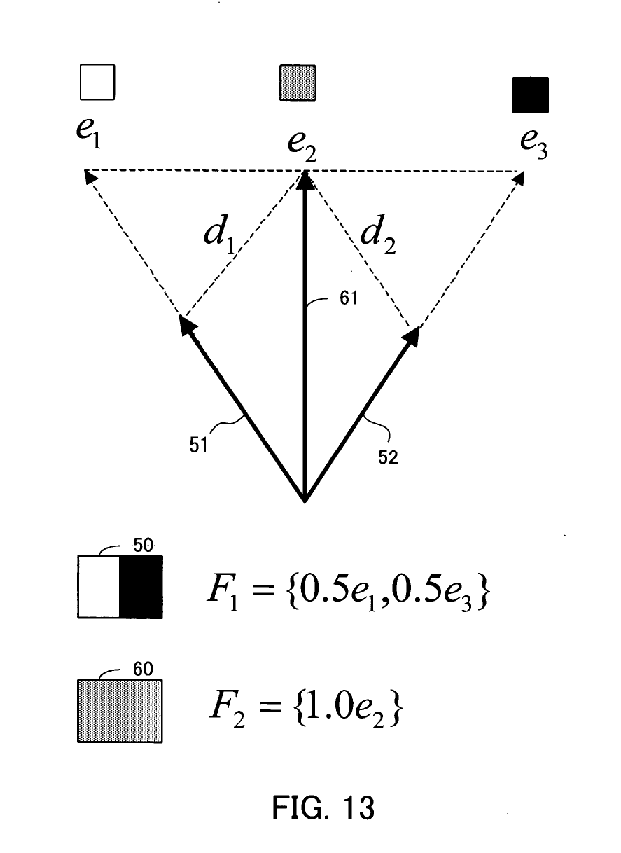

FIG. 13 is a diagram illustrating examples of multiple vectors which are not linearly independent. In this example, a multivector distance between an image 50 composed of 50% of white pixels and 50% of black pixels and an image 60 composed of only grey pixels is considered. At this time, a multivector set F₁ for the image 50 and a multivector set F₂ for the image 60 are respectively expressed as F₁={0.5e₁, 0.5e₃} and F₂={1.0e₂}, where e₁ is an oblique base vector corresponding to white, e₂ is an oblique base vector corresponding to grey, and e₃ is an oblique base vector corresponding to black. That is, while the multivector set for the image 50 includes the two vectors 51 and 52, the multivector set for the image 60 includes only the vector 61. In other words, the numbers of elements in the two multivector sets are different. Therefore, the vector 61 is divided into two vectors 0.5e₂ and 0.5e₂.

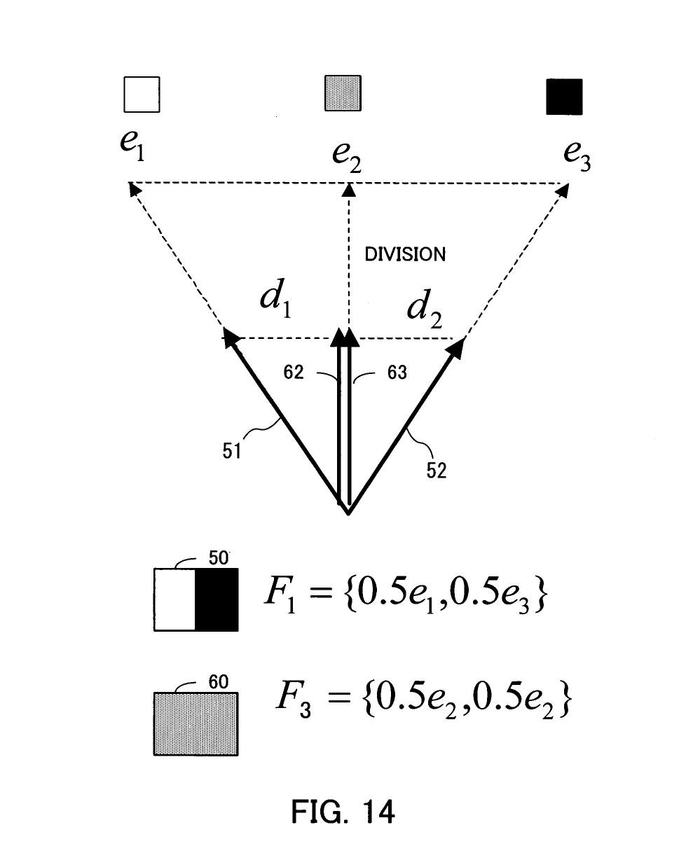

FIG. 14 is a diagram illustrating divided vectors. As illustrated in FIG. 14, the vector 61 illustrated in FIG. 13 is divided into two vectors 62 and 63. A multivector set F₃ obtained by the division is defined as F₃={0.5e₂, 0.5e₂}. In addition, the distance between the multivector sets F₁ and F₃ is defined by the formula (66). In this case, a sum of the distance d₁ between the vectors 51 and 62 and the distance d₂ between the vectors 52 and 63 is obtained. Thus, the δ-distance becomes a positive value, and the problem of the loss of discriminability is solved. In addition, the value of the δ-distance nearly matches the similarity perceived by human beings.

In this embodiment, a distance between vector sets as above is referred to as a multivector distance.

2.4 Feature Set and Approximation

As an extreme example, it is possible to consider a multivector distance between vector sets which are defined as
F={cᵢeᵢ|1≦i≦n}. (68)
Unlike the vector set defined in (64), the vector set F defined in (68) includes the zero vector, and is referred to as a feature set. However, the cost of calculation of distances between feature sets as above is considered to be very great. Therefore, each feature set is approximated by a vector set containing m vectors, which is hereinafter referred to as an m-vector set, where 1≦m<n. An example of a 2-vector set, which is defined in the situation of the aforementioned fourth example, is indicated below. In the fourth example, the similarity is lost.

A feature set F is defined as
F={c₁e₁, c₂e₂, . . . , c₁₂e₁₂}, and (69)
the 2-vector set A is defined as
A={a₁, a₂}, (70)
where
a₁=c₁e₁+c₂e₂+ . . . +c₆e₆, and (71)
a₂=c₇e₇+c₈e₈+ . . . +c₁₂e₁₂. (72)
That is, the 2-vector set A approximates the feature set F. When 2-vector sets for feature sets corresponding to the feature vectors in the fourth example, as the above 2-vector set A for the above feature space F, are denoted Aᵢ (1≦i≦6), the 2-vector sets Aᵢ are respectively identical to the vector sets Fᵢ in the aforementioned fifth example, in which a distance between multivectors is calculated. Therefore, the distance between the 2-vector sets can be defined by using the formula (67). That is, the distances between the above feature sets can be approximated by the distance defined by the formula (67).

Based on the above consideration, the conventional distance between feature sets can be regarded as an approximation using 1-vector sets. That is, the m-vector sets is an extension of the conventional feature vector space.

The approximation method explained in this section is based on division of oblique base vectors. In this example, the oblique base vectors are divided into the two groups, E₁={e₁, e₂, . . . , e₆} and E₂={e₇, e₈, . . . , e₁₂}. The vectors e₁, e₂, . . . , e₆ correspond to the warm colors near yellow, and the vectors e₇, e₈, . . . , e₁₂ correspond to the cold colors near blue. That is, the oblique base vectors should be divided into groups each of which includes oblique base vectors corresponding to colors similar to each other for the reason explained below.

The problem of the loss of discriminability does not occur when no approximation is used, i.e., when the distance between feature sets is used. However, discriminability can be lost when the approximation is used. Nevertheless, loss of discriminability does not occur over the entire feature space since the approximation explained in this section can localize the extent of occurrence of loss of discriminability. In the above example, loss of discriminability does not occur over the two groups E₁ and E₂. Next, general consideration of the distance between two vector sets is given below.

Although the definition by the formula (66) succeeds in the aforementioned fifth example, this definition does not necessarily succeed. An example in which the above definition fails is explained below.

<Approach to Very Similar Feature (Seventh Example)>

Consider two 2-vector sets, A₁={0.7e₁, 0.3e₃} and A₂={e₂, 0 (zero vector)}. At this time, it is assumed that the three oblique base vectors e₁, e₂, and e₃ are close to each other. For example, the three oblique base vectors e₁, e₂, and e₃ correspond to whitish grey, grey, and blackish grey, respectively. Therefore, according to the human color perception, the above two 2-vector sets A₁ and A₂ look similar.

However, when the definition by the formula (66) is used, the distance between the two 2-vector sets A₁ and A₂ is d(0.7e₁, e₂)+d(0.3e₃, 0 (zero vector))≈0.6. Therefore, the distance between the two 2-vector sets is redefined as explained below.

First, each element (the vector aᵢ, 1≦i≦m) of an m-vector set A={a₁, a₂, . . . , aₘ} is divided as
a₁=a₁₁+a₁₂+ . . . +a₁ₘ,
a₂=a₂₁+a₂₂+ . . . +a₂ₘ,
. . .
   aₘ=aₘ₁+aₘ₂+ . . . +aₘₘ,
   where aᵢⱼ (1≦i, j≦m) are vectors, which may include a zero vector or redundantly include identical vectors. The operation of division of each element of a vector set as above is referred to as division of the vector set, and denoted ρ. Thus, the vector set having as its elements the above m² vectors generated from the vector set A by the operation ρ is expressed as
   ρ(A)={a₁₁, a₁₂, . . . , a₁ₘ, a₂₁, a₂₂, . . . a₂ₘ, . . . , aₘ₁, aₘ₂, . . . , aₘₘ}. (73)
   Although there are an infinite number of ways of dividing the vector set A, the set of the infinite number of ways of division is denoted P(A).

Similarly, each element (the vector bᵢ, 1≦i≦m) of another m-vector set B={b₁, b₂, . . . , bₘ} can be divided.

Next, a D-distance between the two m-vector sets, A={a₁, a₂, . . . , aₘ} and B={b₁, b₂, . . . , bₘ} is defined as

$$D ( A , B ) = {min}_{{ρ}_{1} ∈ P ( A ) , {ρ}_{2} ∈ P ( B )} δ ( {ρ}_{1} ( A ) , {ρ}_{2} ( B ) ) . \qquad ( 74 )$$

When the above definition of the D-distance is used, it is possible to define the distance between the two 2-vector sets A₁ and A₂ in the seventh example so that the distance between the two 2-vector sets A₁ and A₂ becomes close to zero.

Variations in the D-distance according to the way of division of vectors are explained below.

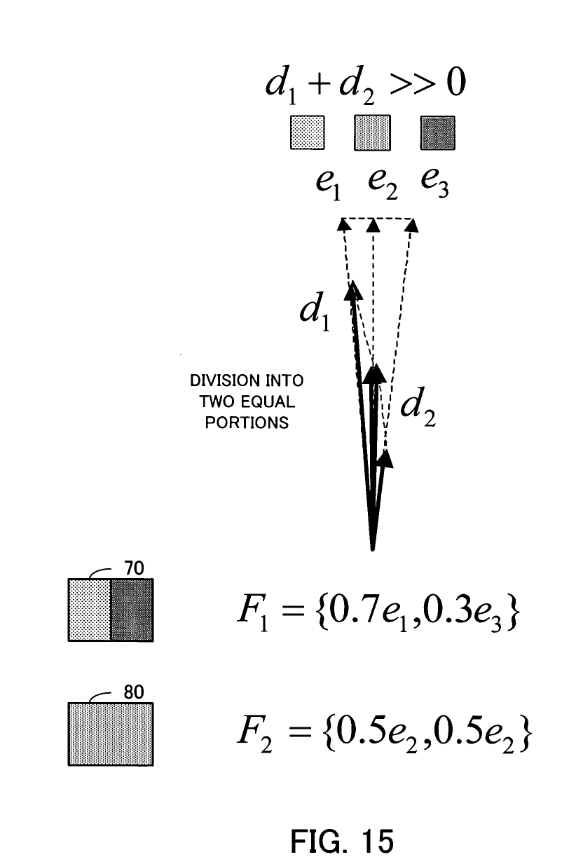

FIG. 15 is a diagram illustrating an example of two vectors produced by equally dividing a single vector. In the example of FIG. 15, an image 80 composed of only grey pixels and an image 70 composed of 50% of whitish grey pixels and 50% of blackish grey pixels are indicated, where the whitish grey pixels in the image 70 is a little more whitish than the grey pixels in the image 80, and the blackish grey pixels in the image 70 is a little more blackish than the grey pixels in the image 80. It is assumed that vector sets corresponding to the images 70 and 80 are expressed as F₁={0.7e₁, 0.3e₃} and F₂={0.5e₂, 0.5e₂}, respectively. That is, the vector indicating the feature of the image 80 composed of only grey pixels is equally divided into two vectors. In this case, d₁(0.7e₁, 0.5e₂)+d₂(0.3e₃, 0.5e₂)>>0, i.e., the calculated distance is apart from the similarity perceived by human beings.

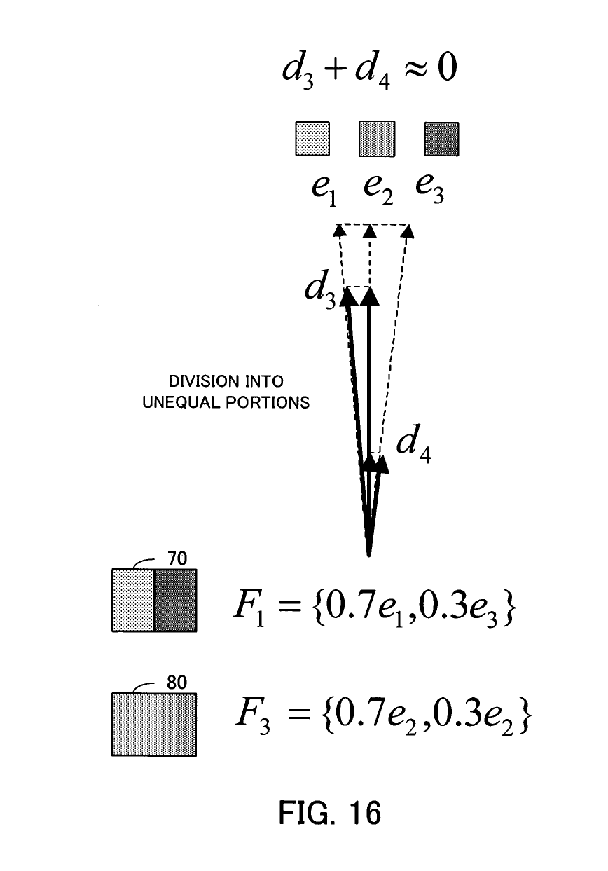

FIG. 16 is a diagram illustrating an example in which a single vector is unequally divided. In the example of FIG. 16, vector sets corresponding to the images 70 and 80 are expressed as F₁={0.7e₁, 0.3e₃} and F₂={0.7e₂, 0.3e₂}, respectively. That is, the vector indicating the feature of the image 80 composed of only grey pixels is unequally divided into two vectors so that the lengths of the two vectors of the image 80 are respectively equal to the lengths of the corresponding vectors of the image 70. In this case, d₁(0.7e₁, 0.7e₂)+d₂(0.3e₃, 0.3e₂) ≈0, i.e., the calculated distance matches the similarity perceived by human beings.

2.5 Approximate Calculation of D-Distance

If the aforementioned definition of the D-distance is directly adopted, the vectors can be divided in an infinite number of ways, and therefore the amount of calculation becomes extremely great. At this time, a method of approximately obtaining the D-distance is explained below. Specifically, an algorithm for obtaining an approximate value of the D-distance between two m-vector sets A={a₁, a₂, . . . , aₘ} and B={b₁, b₂, . . . , bₘ} is indicated. In the following example, in order to enable application to the case where feature quantities are represented by absolute quantities, the feature vectors are divided in correspondence with the sums of the absolute values of the feature quantities of the m-vector sets A and B. The sums of the absolute values of the feature quantities of the m-vector sets A and B are respectively expressed as

$$\begin{matrix}α = {\sum }_{i = 1}^{m} \vert {a}_{i} \vert , and & ( 75 ) \\ β = {\sum }_{j = 1}^{m} \vert {b}_{j} \vert . & ( 76 )\end{matrix}$$

When the feature quantities are relative quantities, the above sums α and β are equal to one. Hereinbelow, the D-distance is indicated by D, the zero vector is denoted vector0, and a vector set containing only zero vectors is indicated by O. For example, a vector set {vector0, vector0, vector0} is indicated by O.

Next, a sequence of processing for approximate calculation of the D-distance is explained below.

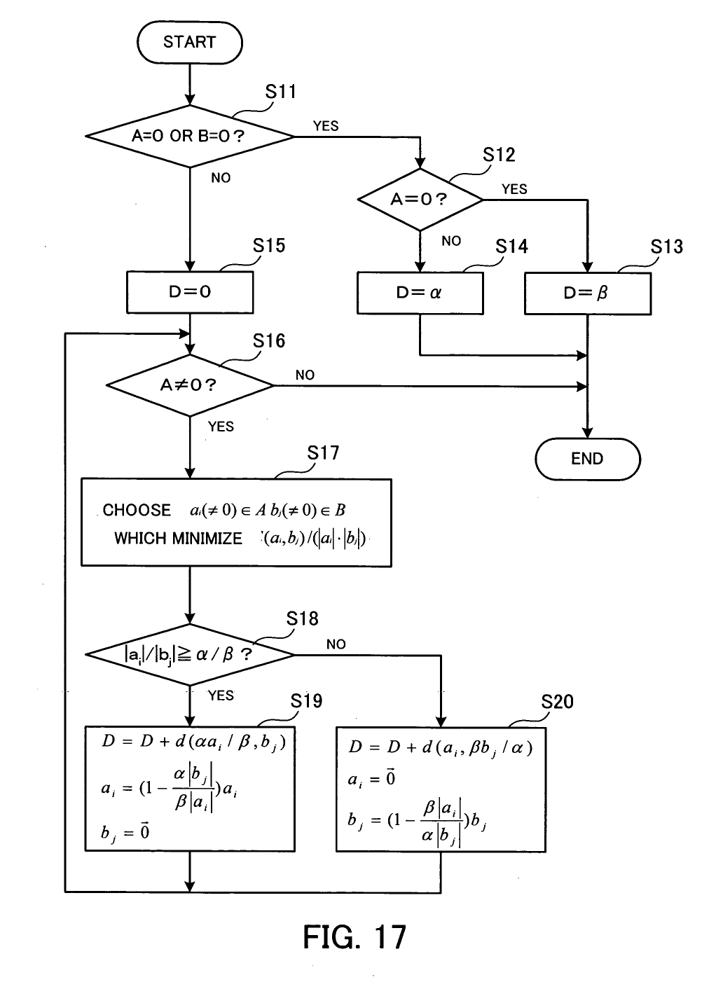

FIG. 17 is a flowchart indicating a sequence of processing for approximate calculation of a D-distance. The processing of FIG. 17 is performed by the distance calculation unit 124 illustrated in FIG. 4.

[Step S11] It is determined whether or not the condition that A=O or B=O is satisfied. When yes is determined, the operation goes to step S12. When no is determined, the operation goes to step S15.

[Step S12] It is determined whether or not the condition that A=O is satisfied. When yes is determined, the operation goes to step S13. When no is determined, the operation goes to step S14.

[Step S13] The D-distance D is set as D=β, and the sequence of FIG. 17 is completed.

[Step S14] The D-distance D is set as D=α, and the sequence of FIG. 17 is completed.

[Step S15] The D-distance D is set as D=α.

[Step S16] It is determined whether or not the condition that A≠O is satisfied. When yes is determined, the operation goes to step S17. When no is determined, the sequence of FIG. 17 is completed. Thus, the processing in steps S17 to S20 are repeated while ADO.

[Step S17] One aᵢ of nonzero vectors included in the vector set A and one bⱼ of nonzero vectors included in the vector set B which minimize (aᵢ, bⱼ)/(|aᵢ|·|bⱼ|) are determined.

[Step S18] It is determined whether or not the condition that |aᵢ|/|bⱼ|≧α/β is satisfied. When yes is determined, the operation goes to step S19. When no is determined, the operation goes to step S20.

[Step S19] The D-distance D is set as D=D+d(αaᵢ/β, bⱼ), the vector aᵢ in the m-vector sets A is replaced with {1-(α|bⱼ|/β|aᵢ|)}aᵢ, and the vector bⱼ in the m-vector sets B is replaced with a zero vector. Thereafter, the operation goes to step S16.

[Step S20] The D-distance D is set as D=D+d(aᵢ, βbⱼ/α), the vector aᵢ in the m-vector sets A is replaced with a zero vector, and the vector bⱼ in the m-vector sets B is replaced with {1-(β|aᵢ|/α|bⱼ|)}bⱼ. Thereafter, the operation goes to step S16.

The basic concept of the above algorithm is as follows.

The one aᵢ of nonzero vectors included in the vector set A and the one bⱼ of nonzero vectors included in the vector set B which minimize (aᵢ, bⱼ)/(|aᵢ·|bⱼ|) are chosen. That is, a pair of nonzero vectors aᵢ and bⱼ are chosen so that a unit vector in the same direction as the vector aᵢ and a unit vector in the same direction as the vector bⱼ are nearest. Then, the whole of one of the vectors aᵢ and bⱼ and the whole or a portion of the other of the vectors aᵢ and bⱼ are extracted (cut out) as vectors corresponding to each other so that the ratio between the length of the whole of the one and the length of the whole or the portion of the other is α:β. Subsequently, the distance between the extracted vectors is obtained and added to the current value of the D-distance D, which is zero or an accumulation of at least one distance between previously extracted vectors. Further, the above vectors aᵢ and bⱼ are respectively shortened by the lengths of the corresponding vectors extracted as above. Since at least one of the vectors aᵢ and bⱼ is fully extracted, the at least one of the vectors aᵢ and bⱼ is shortened to a zero vector. The ratio between the lengths of the corresponding vectors extracted as above is α:β, and this ratio is unchanged in every pair of corresponding vectors. Therefore, finally, the vector sets A and B concurrently become a vector set O containing only zero vectors.

The above operations of cutting out vectors determine the division of vector sets, and the correspondence relationships between the vectors generated by the division determines the one-to-one correspondences in the δ-distance between the divided vector sets.

According to the above method, every time, a pair of nonzero vectors aᵢ and bⱼ are chosen so that a distance between a unit vector in the same direction as the vector aᵢ and a unit vector in the same direction as the vector bⱼ is minimized. That is, processing for choosing a pair of feature vectors which have directions nearest to each other, and cutting out portions which realize a pair of corresponding vectors is repeated. Therefore, the distance calculated as above can be expected to be near to the D-distance.

The approximation of the distance between feature sets is based on the above definition. In addition, although the problems of the discriminability and the similarity is not completely solved as long as approximation is performed, the problems are more localized as the value m increases. Further, the conventionally used feature vectors are the same as approximation based on 1-vector sets. That is, the approximation of the distance defined in this section is a generation of the conventional distance between feature vectors.

3. Search Method

Hereinbelow, a search method in a multivector feature space is explained. The search is performed by the search unit 123 illustrated in FIG. 4. In multivector feature spaces, the search methods are roughly classified into the following two methods (1) and (2) according to whether vector sets are generated in advance or at the time of searching.

(1) Method in which Vector Sets are Generated at the Time of Searching

In a secondary storage such as the HDD 103, a plurality of sets of identifiers of objects such as images and feature quantities which are automatically extracted from the objects are stored in advance. In addition, information on an oblique basis is also stored in advance. Further, at the time of searching, m-vector sets are generated based on the feature quantities and the oblique basis, and a similarity search is performed by calculating D-distances. When this search method is used, the plurality of sets of the feature quantities and the identifiers of the objects are also stored in the storage device 110 illustrated in FIG. 4.

According to the above search method, it is unnecessary to store vector sets in advance. Therefore, when m>2, it is sufficient for the secondary storage to have small capacity, although it is necessary to generate the vector sets at the time of searching.

(2) Method in which Vector Sets are Generated in Advance of Searching

In a secondary storage such as the HDD 103, m-vector sets generated from feature quantities and an oblique basis are stored in advance. In addition, a similarity search is performed by using the m-vector sets and D-distances. The explanations of the present embodiment are basically based on the search method (2).

According to the search method (2), it is necessary to store vector sets in advance. Therefore, when m>2, the load of storing the vector sets is heavy.

Although there is a trade-off relationship between the search methods (1) and (2) as explained above, generally, the search method (2) is considered to be appropriate in the case where m=1, and the search method (1) is considered to be appropriate in the case where m>2.

When the processing explained above is performed, the present embodiment has the following advantages.

(a) Improvement in Accuracy

Since a multivector feature space is used, it is possible to improve the accuracy compared with the conventional method using the quadratic-form distance.

(b) Improvement in Performance

When an approximation of the feature space is performed, it is possible to improve the performance. In addition, the performance can also be improved by approximately obtaining the D-distance.

(c) Improvement in Discriminability

When distances between each pair of vectors in a multivector feature space are obtained according to the present embodiment, it is possible to improve the discriminability without impairing the similarity between features.

4. Differences from EMD

Hereinbelow, the differences of the present embodiment from the EMD technique disclosed in the aforementioned Y. Rubner reference are explained below. A great difference is that entire feature vectors are fully compared in every operation of comparison in a multivector feature space defined in the present embodiment, while partial matching is performed in the EMD technique in the case where the total numbers of feature quantities in two signatures are different.

In the aforementioned image histogram, the feature quantities are relative quantities in some cases, or absolute quantities in other cases. In the former cases, each feature quantity is based on a proportion of a predetermined color in an entire area. In the latter cases, each feature quantity is based on the number of pixels having a predetermined color. According to EMD, when the feature quantities are relative quantities, and the total numbers of the feature quantities in two signatures are different, partial matching is performed, although full matching is performed when the feature quantities are absolute quantities.

On the other hand, according to the method in the present embodiment, the numbers of the feature vectors included in two vector sets to be compared are always equalized. Specifically, a portion or all of feature vectors in at least one of the two vector sets including a smaller number of feature vectors are divided. Thus, every feature vector in the two vector sets can be used as one of a pair of vectors in a one-to-one correspondence for calculation of a distance. Therefore, even when the total numbers of feature quantities in two vector sets are different, full matching can be performed.

The capability of full matching on every occasion is especially effective when the absolute quantities of feature quantities is significant. For example, in the case of documents, full matching of feature quantities based on absolute quantities is important. That is, in the similarity search of a document, a frequency of occurrences of each word or a weighted frequency of occurrences of each word may be used as a feature quantity. In this case, the dimension is equal to the number of words. However, the similarity search is not performed based on all of the words, and instead at least one word which describes the document well is chosen. Therefore, the commonplace words such as “this” and “do” are excluded. Even when such words are excluded, normally the dimension becomes about one thousand to ten thousand. The frequency of occurrences of each word in each document is an absolute quantity, while the pixels in images, which are mentioned later, are relative. For example, a fact that a specific word is frequently used per se is important.

For example, when a word appears only once in a document U and ten times in a document V, this fact means that this word is important in the document V, or this word more strongly characterizes the document V than other words which appear less frequently in the document V. Therefore, in the case of documents, feature quantities are absolute quantities (the numbers of occurrences of respective words).

In the method according to the present embodiment, even when the total numbers of feature quantities are different (i.e., even when the absolute quantities are significant) as in the similarity search of a document, the feature quantities are fully, not partially, compared. Therefore, similarity between entire objects can be accurately determined.

Further, in order to indicate the advantage of the method according to the present embodiment in the similarity search of images, for example, consider comparison of an image X composed of 1,000 black pixels and 1,000 white pixels and an image Y composed of 1,000 black pixels. According to the EMD, feature quantities are partially compared, and a portion of the feature quantities of the image X (corresponding to the 1,000 black pixels) and all of the feature quantities of the image Y (corresponding to the 1,000 black pixels) match.

On the other hand, according to the method in the present embodiment, as illustrated in FIG. 17, the lengths of vectors forming each vector pair are shortened according to the ratio (|α|/|β|) of the absolute values of feature quantities, where the reduction in the lengths of the vectors correspond to portions of the vectors which are cut out. Therefore, even when the original feature quantities are absolute quantities, all of the feature quantities can be compared.

5. Additional Matters

The above processing functions can be realized by a computer. In this case, a program describing details of processing for realizing the functions which the multimedia-data search apparatus should have is provided. When the computer executes the program, the above processing functions can be realized on the computer.

The program describing the details of the processing can be stored in a recording medium which can be read by the computer. The recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the program into the market, for example, it is possible to sell a portable recording medium such as a DVD or a CD-ROM in which the program is recorded. Alternatively, it is possible to store the program in a storage device belonging to a server computer, and transfer the program to another computer through a network.

The computer which executes the program stores the program in a storage device belonging to the computer, where the program is originally recorded in, for example, a portable recording medium. The computer reads the program from the storage device, and performs processing in accordance with the program. Alternatively, the computer may directly read the program from the portable recording medium for performing processing in accordance with the program. Further, the computer can sequentially execute processing in accordance with each portion of the program every time the portion of the program is transferred from the server computer.

As explained above, according to the present invention, features of multimedia-data items are represented by feature vectors, and a sum of distances between a pair of vectors in a one-to-one correspondence is obtained, where the vectors are feature vectors of the multimedia-data items to be compared. Then, the degree of similarity between the multimedia-data items is determined based on the sum of the distances. Thus, it is possible to accurately calculate the degree of similarity without impairing discriminability between multimedia-data items.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A similarity determination program for determining similarity between multimedia-data items by using a computer, said similarity determination program makes said computer comprise the functions of:
an oblique-base-vector storage unit which stores oblique base vectors being respectively provided in correspondence with representative features of said multimedia-data items, and respectively indicating the representative features by directions of the oblique base vectors;
an input unit which inputs first and second multimedia-data items to be compared;
a vector-set generation unit which analyzes said first and second multimedia-data items inputted by said input unit, determines feature quantities, respectively corresponding to said representative features, of each of said first and second multimedia-data items so that each of the feature quantities indicates a degree of inclusion of information corresponding to one of the representative features in said each of the first and second multimedia-data items, generates first and second feature vectors for said first and second multimedia-data items, respectively, by multiplying each of the oblique base vectors by one of the feature quantities corresponding to said each of the oblique base vectors for each of the first and second multimedia-data items, and forms first and second vector sets respectively corresponding to the first and second multimedia-data items so that the first feature vectors constitute the first vector set, and the second feature vectors constitute the second vector set;
a vector-pair generation unit which makes said first and second vector sets have an identical number of feature vectors, and generates a plurality of vector pairs by establishing one-to-one correspondences between the feature vectors in the first vector set and the feature vectors in the second vector set;
a vector-to-vector distance calculation unit which calculates distances in said plurality of vector pairs, respectively, where each of the distances indicates a first degree of similarity between two feature vectors forming one of said plurality of vector pairs;
a degree-of-similarity calculation unit which calculates a second degree of similarity between said first and second multimedia-data items by summing said distances calculated by said vector-to-vector distance calculation unit; and
an output unit which outputs said second degree of similarity calculated by said degree-of-similarity calculation unit.

2. The similarity determination program according to claim 1, wherein said multimedia-data items are image data items.

3. The similarity determination program according to claim 2, wherein representative colors are defined as said representative features in said oblique-base-vector storage unit, correspondence relationships between said representative colors and colors in images represented by said image data items are predefined in said vector-set generation unit, and each of said feature quantities corresponding to said representative features in each of said images is determined to be a proportion of the number of pixels having one of said representative colors in said each of the images to the total number of pixels constituting said each of the images.

4. The similarity determination program according to claim 1, wherein said vector-pair generation unit classifies the first and second feature vectors in the first and second vector sets into a plurality of groups, and synthesizes feature vectors in each of the plurality of groups, so as to make the first and second vector sets have an identical number of feature vectors.

5. The similarity determination program according to claim 1, wherein said vector-pair generation unit chooses a first one of the feature vectors in said first vector set and a second one of the feature vectors in said second vector set in such a manner that the first and second ones of the feature vectors in the first and second vector sets have directions nearest to each other, and repeatedly cuts out portions forming one of said plurality of vector pairs from the first and second ones of the feature vectors.

6. The similarity determination program according to claim 1, wherein when the number of said oblique base vectors is n, and the oblique base vectors are not linearly independent within an n-dimensional vector space, said oblique base vectors stored in said oblique-base-vector storage unit are linearly independent within an m-dimensional vector space, where n and m are natural numbers satisfying n<m²≦2n.

7. The similarity determination program according to claim 1, wherein said vector-pair generation unit makes the first and second vector sets have an identical number of feature vectors by dividing the feature vectors in said first and second vector sets.

8. The similarity determination program according to claim 7, wherein said vector-pair generation unit extracts a first one of the feature vectors in said first vector set and a second one of the feature vectors in said second vector set, and splits from the first and second ones of the feature vectors in the first and second vector sets vectors having relative lengths corresponding to a ratio between a sum of the feature quantities of said first multimedia-data item and a sum of the feature quantities of said second multimedia-data item.

9. The similarity determination program according to claim 1, wherein when each of said first and second vector sets includes m feature vectors, and m is a natural number, said vector-pair generation unit subdivides each of the m feature vectors in each of said first and second vector sets into m subdivided feature vectors, and generates a plurality of vector pairs each of which is formed of one of the m subdivided feature vectors corresponding to the first vector set and one of the m subdivided feature vectors corresponding to the second vector set.

10. A multimedia-data search program for searching multimedia-data items by using a computer, said multimedia-data search program makes said computer comprise the functions of:
an oblique-base-vector storage unit which stores oblique base vectors being respectively provided in correspondence with representative features of multimedia-data items, and respectively indicating the representative features by directions of the oblique base vectors;
a vector-set storage unit which stores first vector sets each including first feature vectors representing features of each of first multimedia-data items which are to be searched;
an input unit which inputs a second multimedia-data item as a search condition;
a vector-set generation unit which analyzes said second multimedia-data item inputted by said input unit, determines feature quantities, respectively corresponding to said representative features, of the second multimedia-data items so that each of the feature quantities indicates a degree of inclusion of information corresponding to one of the representative features in said second multimedia-data item, generates second feature vectors for said second multimedia-data item by multiplying each of the oblique base vectors by one of the feature quantities corresponding to said each of the oblique base vectors, and forms a second vector sets constituted by the second feature vectors;
a vector-pair generation unit which makes said first vector sets and said second vector sets have an identical number of feature vectors, and generates a plurality of vector pairs by establishing one-to-one correspondences between the feature vectors in each of the first vector sets and the feature vectors in the second vector set;
a vector-to-vector distance calculation unit which calculates distances in said plurality of vector pairs, respectively, where each of the distances indicates a first degree of similarity between two feature vectors forming one of said plurality of vector pairs;
a degree-of-similarity calculation unit which calculates a second degree of similarity between said second multimedia-data item and each of said first multimedia-data items by summing said distances calculated by said vector-to-vector distance calculation unit; and
an output unit which outputs information identifying one of said first multimedia-data items corresponding to a highest value of said second degree of similarity calculated by said degree-of-similarity calculation unit.

11. A similarity determination method for determining similarity between multimedia-data items, comprising the steps of:
(a) storing in advance, in an oblique-base-vector storage unit, oblique base vectors which are respectively provided in correspondence with representative features of said multimedia-data items, and respectively indicate the representative features by directions of the oblique base vectors;
(b) inputting, by an input unit, first and second multimedia-data items to be compared;
(c) using a vector-set generation unit, for analyzing said first and second multimedia-data items inputted by said input unit, determining feature quantities, respectively corresponding to said representative features, of each of said first and second multimedia-data items so that each of the feature quantities indicates a degree of inclusion of information corresponding to one of the representative features in said each of the first and second multimedia-data items, generating first and second feature vectors for said first and second multimedia-data items, respectively, by multiplying each of the oblique base vectors by one of the feature quantities corresponding to said each of the oblique base vectors for each of the first and second multimedia-data items, and forming first and second vector sets respectively corresponding to the first and second multimedia-data items so that the first feature vectors constitute the first vector set, and the second feature vectors constitute the second vector set;
(d) using a vector-pair generation unit, for making said first and second vector sets have an identical number of feature vectors, and generating a plurality of vector pairs by establishing one-to-one correspondences between the feature vectors in the first vector set and the feature vectors in the second vector set;
(e) calculating, by a vector-to-vector distance calculation unit, distances in said plurality of vector pairs, respectively, where each of the distances indicates a first degree of similarity between two feature vectors forming one of said plurality of vector pairs;
(f) calculating, by a degree-of-similarity calculation unit, a second degree of similarity between said first and second multimedia-data items by summing said distances calculated by said vector-to-vector distance calculation unit; and
(g) outputting, by an output unit, said second degree of similarity calculated by said degree-of-similarity calculation unit.

12. A multimedia search method for searching multimedia-data items, comprising the steps of:
(a) storing in advance, in an oblique-base-vector storage unit, oblique base vectors which are respectively provided in correspondence with representative features of multimedia-data items, and respectively indicate the representative features by directions of the oblique base vectors;
(b) storing in advance, in a vector-set storage unit, first vector sets each including first feature vectors representing features of each of first multimedia-data items which are to be searched;
(c) inputting, by an input unit, a second multimedia-data item as a search condition;
(d) using a vector-set generation unit, for analyzing said second multimedia-data item inputted by said input unit, determining feature quantities, respectively corresponding to said representative features, of the second multimedia-data items so that each of the feature quantities indicates a degree of inclusion of information corresponding to one of the representative features in said second multimedia-data item, generating second feature vectors for said second multimedia-data item by multiplying each of the oblique base vectors by one of the feature quantities corresponding to said each of the oblique base vectors, and forming a second vector sets constituted by the second feature vectors;
(e) using a vector-pair generation unit, for making said first vector sets and said second vector sets have an identical number of feature vectors, and generating a plurality of vector pairs by establishing one-to-one correspondences between the feature vectors in each of the first vector sets and the feature vectors in the second vector set;
(f) calculating, by a vector-to-vector distance calculation unit, distances in said plurality of vector pairs, respectively, where each of the distances indicates a first degree of similarity between two feature vectors forming one of said plurality of vector pairs;
(g) calculating, by a degree-of-similarity calculation unit, a second degree of similarity between said second multimedia-data item and each of said first multimedia-data items by summing said distances calculated by said vector-to-vector distance calculation unit; and
(h) outputting, by an output unit, information identifying one of said first multimedia-data items corresponding to a highest value of said second degree of similarity calculated by said degree-of-similarity calculation unit.

13. A similarity determination apparatus for determining similarity between multimedia-data items, comprising:
an oblique-base-vector storage unit which stores oblique base vectors being respectively provided in correspondence with representative features of said multimedia-data items, and respectively indicating the representative features by directions of the oblique base vectors;
an input unit which inputs first and second multimedia-data items to be compared;
a vector-set generation unit which analyzes said first and second multimedia-data items inputted by said input unit, determines feature quantities, respectively corresponding to said representative features, of each of said first and second multimedia-data items so that each of the feature quantities indicates a degree of inclusion of information corresponding to one of the representative features in said each of the first and second multimedia-data items, generates first and second feature vectors for said first and second multimedia-data items, respectively, by multiplying each of the oblique base vectors by one of the feature quantities corresponding to said each of the oblique base vectors for each of the first and second multimedia-data items, and forms first and second vector sets respectively corresponding to the first and second multimedia-data items so that the first feature vectors constitute the first vector set, and the second feature vectors constitute the second vector set;
a vector-pair generation unit which makes said first and second vector sets have an identical number of feature vectors, and generates a plurality of vector pairs by establishing one-to-one correspondences between the feature vectors in the first vector set and the feature vectors in the second vector set;
a vector-to-vector distance calculation unit which calculates distances in said plurality of vector pairs, respectively, where each of the distances indicates a first degree of similarity between two feature vectors forming one of said plurality of vector pairs;
a degree-of-similarity calculation unit which calculates a second degree of similarity between said first and second multimedia-data items by summing said distances calculated by said vector-to-vector distance calculation unit; and
an output unit which outputs said second degree of similarity calculated by said degree-of-similarity calculation unit.

14. A multimedia search apparatus for searching multimedia-data items, comprising:
an oblique-base-vector storage unit which stores oblique base vectors being respectively provided in correspondence with representative features of multimedia-data items, and respectively indicating the representative features by directions of the oblique base vectors;
a vector-set storage unit which stores first vector sets each including first feature vectors representing features of each of first multimedia-data items which are to be searched;
an input unit which inputs a second multimedia-data item as a search condition;
a vector-set generation unit which analyzes said second multimedia-data item inputted by said input unit, determines feature quantities, respectively corresponding to said representative features, of the second multimedia-data items so that each of the feature quantities indicates a degree of inclusion of information corresponding to one of the representative features in said second multimedia-data item, generates second feature vectors for said second multimedia-data item by multiplying each of the oblique base vectors by one of the feature quantities corresponding to said each of the oblique base vectors, and forms a second vector sets constituted by the second feature vectors;
a vector-pair generation unit which makes said first vector sets and said second vector sets have an identical number of feature vectors, and generates a plurality of vector pairs by establishing one-to-one correspondences between the feature vectors in each of the first vector sets and the feature vectors in the second vector set;
a vector-to-vector distance calculation unit which calculates distances in said plurality of vector pairs, respectively, where each of the distances indicates a first degree of similarity between two feature vectors forming one of said plurality of vector pairs;
a degree-of-similarity calculation unit which calculates a second degree of similarity between said second multimedia-data item and each of said first multimedia-data items by summing said distances calculated by said vector-to-vector distance calculation unit; and
an output unit which outputs information identifying one of said first multimedia-data items corresponding to a highest value of said second degree of similarity calculated by said degree-of-similarity calculation unit.

15. A computer-readable recording medium which stores a similarity determination program for determining similarity between multimedia-data items by using a computer, said similarity determination program makes said computer comprise the functions of:
an oblique-base-vector storage unit which stores oblique base vectors being respectively provided in correspondence with representative features of said multimedia-data items, and respectively indicating the representative features by directions of the oblique base vectors;
an input unit which inputs first and second multimedia-data items to be compared;
a vector-set generation unit which analyzes said first and second multimedia-data items inputted by said input unit, determines feature quantities, respectively corresponding to said representative features, of each of said first and second multimedia-data items so that each of the feature quantities indicates a degree of inclusion of information corresponding to one of the representative features in said each of the first and second multimedia-data items, generates first and second feature vectors for said first and second multimedia-data items, respectively, by multiplying each of the oblique base vectors by one of the feature quantities corresponding to said each of the oblique base vectors for each of the first and second multimedia-data items, and forms first and second vector sets respectively corresponding to the first and second multimedia-data items so that the first feature vectors constitute the first vector set, and the second feature vectors constitute the second vector set;
a vector-pair generation unit which makes said first and second vector sets have an identical number of feature vectors, and generates a plurality of vector pairs by establishing one-to-one correspondences between the feature vectors in the first vector set and the feature vectors in the second vector set;
a vector-to-vector distance calculation unit which calculates distances in said plurality of vector pairs, respectively, where each of the distances indicates a first degree of similarity between two feature vectors forming one of said plurality of vector pairs;
a degree-of-similarity calculation unit which calculates a second degree of similarity between said first and second multimedia-data items by summing said distances calculated by said vector-to-vector distance calculation unit; and
an output unit which outputs said second degree of similarity calculated by said degree-of-similarity calculation unit.

16. A computer-readable recording medium which stores a multimedia-data search program for searching multimedia-data items by using a computer, said multimedia-data search program makes said computer comprise the functions of:
an oblique-base-vector storage unit which stores oblique base vectors being respectively provided in correspondence with representative features of multimedia-data items, and respectively indicating the representative features by directions of the oblique base vectors;
a vector-set storage unit which stores first vector sets each including first feature vectors representing features of each of first multimedia-data items which are to be searched;
an input unit which inputs a second multimedia-data item as a search condition;
a vector-set generation unit which analyzes said second multimedia-data item inputted by said input unit, determines feature quantities, respectively corresponding to said representative features, of the second multimedia-data items so that each of the feature quantities indicates a degree of inclusion of information corresponding to one of the representative features in said second multimedia-data item, generates second feature vectors for said second multimedia-data item by multiplying each of the oblique base vectors by one of the feature quantities corresponding to said each of the oblique base vectors, and forms a second vector sets constituted by the second feature vectors;
a vector-pair generation unit which makes said first vector sets and said second vector sets have an identical number of feature vectors, and generates a plurality of vector pairs by establishing one-to-one correspondences between the feature vectors in each of the first vector sets and the feature vectors in the second vector set;
a vector-to-vector distance calculation unit which calculates distances in said plurality of vector pairs, respectively, where each of the distances indicates a first degree of similarity between two feature vectors forming one of said plurality of vector pairs;
a degree-of-similarity calculation unit which calculates a second degree of similarity between said second multimedia-data item and each of said first multimedia-data items by summing said distances calculated by said vector-to-vector distance calculation unit; and
an output unit which outputs information identifying one of said first multimedia-data items corresponding to a highest value of said second degree of similarity calculated by said degree-of-similarity calculation unit.
